(19) United States
(12) Patent Application Publication
(10) Pub. No.: US 2026/0155019 A1
(43) Pub. Date: Jun. 4, 2026

(54) SCRATCH-OFF INSTANT LOTTERY TICKET AUTO-REVEAL SYSTEM

(71) Applicant: Brightstar Global Solutions Corporation, Providence, RI (US)

(72) Inventors: Apostolos D. Kallis, Barrington, RI (US); Nicholas G. Fazzano, Providence, RI (US)

(21) Appl. No.: 18/966,323

(22) Filed: Dec. 3, 2024

(51) Int. Cl. G07F 17/32

(52) U.S. Cl. CPC G07F 17/3241; G07F 17/3237; G07F 17/329

(57) ABSTRACT

A scratch-off instant lottery ticket auto-reveal system and methods of operation thereof, wherein in various embodiments the system includes an electronic ticket purchasing system, a lottery central system, a ticket holder and dispenser, a ticket activator, a first ticket image provider, a ticket revealer, a second ticket imager provider, a ticket validator, and a ticket storer.

### CROSS REFERENCE TO RELATED APPLICATIONS

This application is related to the following commonly owned co-pending patent application: U.S. Application No. ______, entitled “SCRATCH-OFF INSTANT LOTTERY TICKET AUTO-REVEAL SYSTEM AND METHODS OF OPERATION THEREOF,” Attorney Docket No. 027438-3392/P003177-001.

### BACKGROUND

The present disclosure relates to scratch-off instant lottery ticket auto-reveal systems and methods of operation thereof.

Scratch-off instant ticket lottery games have been widely employed. Various scratch-off instant lottery tickets include variable symbols on a substrate that are positioned under a scratch-off coating. The scratch-off-coating (“SOC”) is used to ensure that the instant lottery ticket has not been previously used, played, or modified. Scratch-off instant lottery tickets may be printed on a long strip that may be fan-folded and provided as a pack of instant lottery tickets. Scratch-off instant lottery tickets in such packs may be separated along perforations formed between adjacent scratch-off instant lottery tickets in such packs. Each scratch-off instant lottery ticket may be sold from a pack to a purchaser who can remove the SOC to reveal the variable symbols on the substrate of the scratch-off instant lottery ticket that may indicate an award amount associated with the scratch-off instant lottery ticket.

### BRIEF SUMMARY

In various embodiments, the present disclosure relates to a scratch-off instant lottery ticket auto-reveal system including a lottery ticket holder and dispenser that comprises a housing, a plurality of ticket drawers in the housing, each of the plurality of ticket drawers configured to hold a pack of instant lottery tickets, and one or more ticket bursters in the housing, each ticket burster operable to receive a purchased instant lottery ticket from one of the plurality of ticket drawers and dispense that purchased instant lottery ticket. Each of the instant lottery tickets comprising: a ticket barcode associated with a ticket identifier that uniquely identifies that instant lottery ticket, a validation barcode associated with a validation identifier for that instant lottery ticket, and a scratch-off coating (“SOC”) covering the validation barcode. The lottery ticket holder and dispenser is operable to track dispenser ticket supply data for instant lottery tickets loaded into the plurality of ticket drawers based on the ticket identifiers for the loaded instant lottery tickets, and provide the dispenser ticket supply data to a lottery central system. The system further includes: a barcode scanner operable to scan the ticket barcode printed on the purchased instant lottery ticket to obtain the ticket identifier for the purchased instant lottery ticket; a ticket activator operable to provide the ticket identifier of the purchased instant lottery ticket to the lottery central system to enable activation of the purchased instant lottery ticket by the lottery central system; and a ticket revealer comprising an SOC remover operable to remove the SOC covering the validation barcode of the purchased instant lottery ticket to obtain a revealed instant lottery ticket. The system further includes:
a ticket imager provider operable to capture image data for the revealed instant lottery ticket with the SOC removed from the validation barcode, the ticket image provider operable to provide the image data to the lottery central system; and a ticket validator operable to provide the validation identifier of the revealed instant lottery ticket to the lottery central system.

In various other embodiments, the present disclosure relates to a scratch-off instant lottery ticket auto-reveal system including a lottery ticket holder and dispenser that comprises: a first housing, a plurality of ticket drawers in the housing, each of the plurality of ticket drawers configured to hold a pack of instant lottery tickets, and one or more ticket bursters in the housing, each ticket burster operable to receive a purchased instant lottery ticket from one of the plurality of ticket drawers and dispense that purchased instant lottery ticket. Each of the instant lottery tickets comprises: a ticket barcode on a back surface of the instant lottery ticket, the ticket barcode associated with a ticket identifier that uniquely identifies that instant lottery ticket, a validation barcode on a front surface of the instant lottery ticket, the validation barcode associated with a validation identifier for that instant lottery ticket, and a scratch-off coating (“SOC”) covering the validation barcode. The system further includes: a barcode scanner operable to scan the ticket barcode printed on the back surface of the purchased instant lottery ticket to obtain the ticket identifier for the purchased instant lottery ticket; a ticket activator operable to provide the ticket identifier of the purchased instant lottery ticket to a lottery central system to enable activation of the purchased instant lottery ticket by the lottery central system; and a ticket revealer comprising an SOC remover operable to remove the SOC covering the validation barcode of the purchased instant lottery ticket to obtain a revealed instant lottery ticket. The system further includes: a ticket imager provider operable to capture image data for the revealed instant lottery ticket with the SOC removed from the validation barcode, the ticket image provider operable to provide the image data to the lottery central system; and a ticket validator operable to provide the validation identifier of the revealed instant lottery ticket to the lottery central system.

In various other embodiments, the present disclosure relates to a scratch-off instant lottery ticket auto-reveal system including a lottery ticket holder and dispenser that comprises: first housing, a plurality of ticket drawers in the housing, each of the plurality of ticket drawers configured to hold a pack of instant lottery tickets, and one or more ticket bursters in the housing, each ticket burster operable to receive a purchased instant lottery ticket from one of the plurality of ticket drawers and dispense that purchased instant lottery ticket. Each of the instant lottery tickets includes: a ticket barcode on a back surface of the instant lottery ticket, the ticket barcode associated with a ticket identifier that uniquely identifies that instant lottery ticket, a validation barcode on a front surface of the instant lottery ticket, the validation barcode associated with a validation identifier for that instant lottery ticket, and a scratch-off coating (“SOC”) covering the validation barcode. The system further includes: a barcode scanner operable to scan the ticket barcode printed on the back surface of the purchased instant lottery ticket to obtain the ticket identifier for the purchased instant lottery ticket; a ticket activator operable to provide the ticket identifier of the purchased instant lottery ticket to a lottery central system; and a ticket revealer comprising an SOC remover operable to remove the SOC covering the validation barcode of the purchased instant lottery ticket to obtain a revealed instant lottery ticket, and a combined ticket imager provider and ticket validator operable to capture image data for the revealed instant lottery ticket with the SOC removed from the validation barcode, and to provide the image data to the lottery central system that comprises the validation identifier of the revealed instant lottery ticket.

Additional features are described in, and will be apparent from, the following Detailed Description and the figures.

### BRIEF DESCRIPTION OF THE SEVERAL VIEWS OF THE DRAWINGS

FIG. 1 is diagrammatic view of a scratch-off instant lottery ticket auto-reveal system in accordance with one example embodiment of the present disclosure.

FIG. 2 is a front perspective view of an example lottery ticket holder and dispenser of the scratch-off instant lottery ticket auto-reveal system of FIG. 1, shown with a left side wall outer panel removed, showing three ticket drawer columns and three movable ticket bursters respectively associated with the three ticket drawer columns.

FIG. 3 is a front fragmentary perspective view of the lottery ticket holder and dispenser of FIG. 2, showing one of the movable ticket bursters.

FIG. 4 is a left side view of the movable ticket burster of FIG. 3.

FIG. 5 is a diagrammatic view of a ticket activator of the scratch-off instant lottery ticket auto-reveal system of FIG. 1.

FIG. 6 is a diagrammatic view of a first ticket image provider of the scratch-off instant lottery ticket auto-reveal system of FIG. 1.

FIG. 7 is a diagrammatic view of a ticket revealer of the scratch-off instant lottery ticket auto-reveal system of FIG. 1.

FIG. 8 is a diagrammatic view of a second ticket image provider of the scratch-off instant lottery ticket auto-reveal system of FIG. 1.

FIG. 9 is a diagrammatic view of a ticket validator of the scratch-off instant lottery ticket auto-reveal system of FIG. 1.

FIG. 10 is a diagrammatic view of a ticket storer of the scratch-off instant lottery ticket auto-reveal system of FIG. 1.

FIG. 11 is a flow diagram showing one example method of operation of the scratch-off instant lottery ticket auto-reveal system of FIG. 1 in accordance with one example embodiment of the present disclosure.

### DETAILED DESCRIPTION

In various embodiments, the present disclosure relates to a scratch-off instant lottery ticket auto-reveal systems and methods of operation thereof.

In various embodiments, the scratch-off instant lottery ticket auto-reveal system includes: (1) an electronic ticket purchasing system; (2) a lottery central system; (3) a ticket holder and dispenser; (4) a ticket activator; (5) a first ticket image provider; (6) a ticket revealer; (7) a second ticket imager provider; (8) a ticket validator; and (9) a ticket storer. In various embodiments, certain of these physical components of the scratch-off instant lottery ticket auto-reveal system can be combined, but for explanatory purposes these components are separately described herein.

In various embodiments, the ticket holder and dispenser, the ticket activator, the first ticket image provider, the ticket revealer, the second ticket imager provider, the ticket validator, and the ticket storer of the scratch-off instant lottery ticket auto-reveal system are configured to receive, hold, process, and store a plurality of different scratch-off instant lottery tickets at a secure location in a jurisdiction in which such instant lottery tickets can be sold.

In various embodiments, the electronic ticket purchasing system and the lottery central system of the scratch-off instant lottery ticket auto-reveal system enable a purchaser to employ a purchaser electronic device to determine the available different scratch-off instant lottery tickets and to purchase any of the available scratch-off instant lottery tickets.

In various embodiments, for each scratch-off instant lottery ticket purchased by a purchaser, the ticket holder and dispenser, the ticket activator, the first ticket image provider, the ticket revealer, the second ticket imager provider, the ticket validator, and the ticket storer of the scratch-off instant lottery ticket auto-reveal system are configured to co-act to: (1) dispense the scratch-off instant lottery ticket from the ticket holder and dispenser; (2) obtain an image of the scratch-off instant lottery ticket with the SOC thereof in-tact; (3) send image data of the scratch-off instant lottery ticket with the SOC thereof in-tact to the purchaser electronic device to enable the purchaser electronic device to display an image of the scratch-off instant lottery ticket with the SOC thereof in-tact to the purchaser; (4) remove the SOC from the scratch-off instant lottery ticket; (5) obtain an image of the scratch-off instant lottery ticket with the SOC removed; (6) send image data of the scratch-off instant lottery ticket with the SOC removed to the purchaser electronic device to enable the purchaser electronic device to display an image of the scratch-off instant lottery ticket with the SOC thereof removed to the purchaser; (7) determine if the scratch-off instant lottery ticket is a winning instant lottery ticket, and if so the award amount; (8) based on the award amount, initiate a redemption process that includes either payment of the award amount to the purchaser or a process that enables the purchaser to obtain payment of the award amount at a lottery ticket office; and (9) store the scratch-off instant lottery ticket with the SOC thereof removed for a period of time, wherein the temporary storage location is based on the award amount (if any).

For a better understanding of the present disclosure, example scratch-off instant lottery tickets are first generally described herein. Various known scratch-off instant lottery tickets are single game instant lottery tickets. An example single game instant lottery ticket can include: (1) a ticket substrate having a front surface and a back surface; (2) a predefined scratch-off area on the front surface; (3) variable lottery game symbols printed on the predefined scratch-off area; (4) a scratch-off coating (“SOC”) covering the variable lottery game symbols and the predefined scratch-off area; and (5) variable instant lottery ticket information printed on the front and back surfaces. The instant lottery ticket information can include text, one or more ticket numbers, one or more ticket codes (such as barcodes), and other instant lottery ticket information that is in human readable and machine readable forms. Certain of the instant lottery ticket information: (a) identifies the scratch-off instant lottery ticket; (b) the set, run, and/or pack of scratch-off instant lottery tickets that the scratch-off instant lottery ticket is part of; and (c) other inventory control information. Various known single game scratch-off instant lottery tickets include multiple predefined scratch-off areas, multiple sets of variable lottery game symbols printed on the predefined scratch-off areas, and multiple SOCs covering the variable lottery game symbols. Various known scratch-off instant lottery tickets are multi-game scratch-off instant lottery tickets and can be larger than single game scratch-off instant lottery tickets. Various scratch-off instant lottery tickets are often arranged after manufacture (which includes after complete printing) in instant lottery ticket packs for storage, organization, sorting, picking, shipping to instant lottery ticket distributors or ticket retailers, and validation. A pack of instant lottery tickets can include all of the instant lottery tickets attached to each other but joined by perforations. Such instant lottery tickets of a pack can be detached from each other along such perforations.

For brevity, the scratch-off instant lottery ticket auto-reveal system is referred to herein as the “auto-reveal system” or the “system.”

For brevity, a scratch-off instant lottery ticket is referred to sometimes herein as the “instant lottery ticket” or the “ticket.” After being dispensed by the ticket holder and dispenser but prior to removal of the SOC of the ticket, the ticket is sometimes referred to herein as the “purchased ticket” or “dispensed ticket.” After removal of all or a portion of the SOC of the dispensed ticket by the ticket revealer, the ticket is sometimes referred to herein as the “revealed ticket.” In various embodiments, the “dispensed ticket” has been dispensed from the ticket holder and dispenser, but has not been physically dispensed to a purchaser.

For brevity and simplicity, while the scratch-off instant lottery ticket auto-reveal system is configured to enable multiple different purchasers to purchase multiple different tickets, the present disclosure describes the auto-reveal system in relation to a single purchaser and a single ticket.

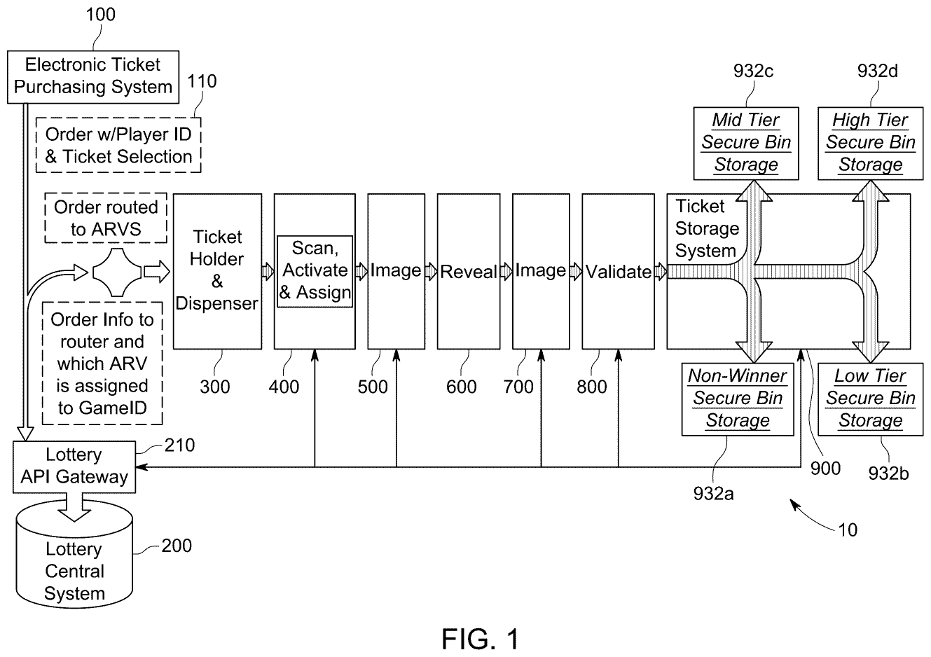

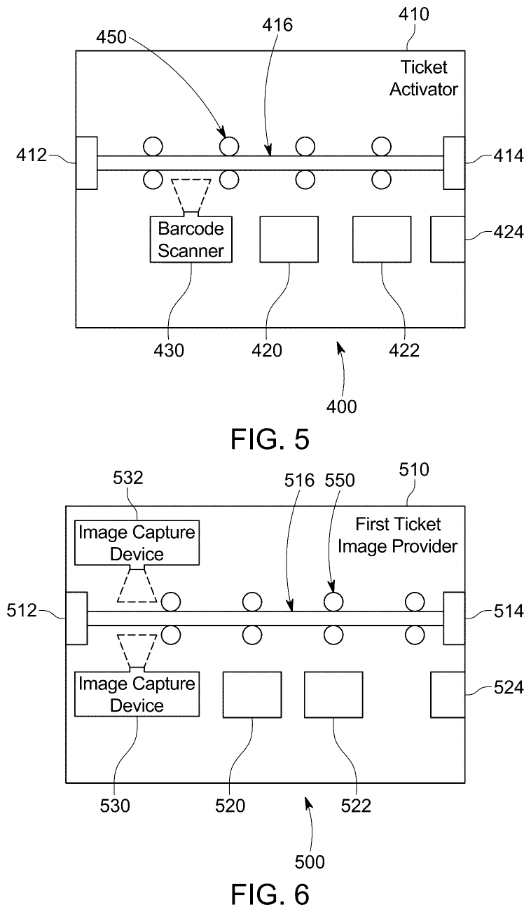

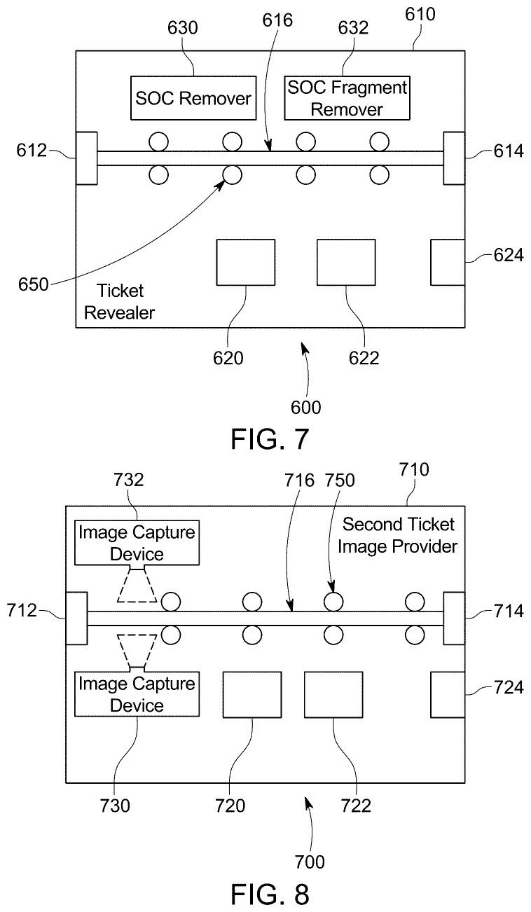

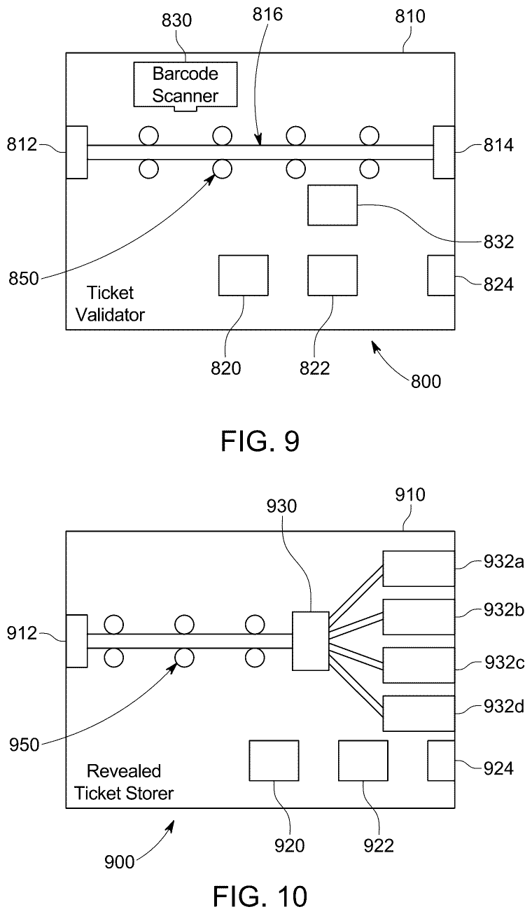

FIGS. 1 to 10 illustrate certain of the physical components of the auto-reveal system 10. These components can be alternatively configured in accordance with the present disclosure. Additionally, as mentioned above, certain combinations of these physical components can be combined in accordance with the present disclosure.

Turning now to FIG. 1, a scratch-off instant lottery ticket auto-reveal system of one example embodiment of the present disclosure is generally illustrated and indicated by numeral 10.

The scratch-off instant lottery ticket auto-reveal system 10 includes: (1) an electronic ticket purchasing system 100; (2) a lottery central system 200; (3) a ticket holder and dispenser 300; (4) a ticket activator 400; (5) a first ticket image provider 500; (6) a ticket revealer 600; (7) a second ticket imager provider 700; (8) a ticket validator 800; and (9) a revealed ticket storer 900.

In various embodiments, the electronic ticket purchasing system 100 and the lottery central system 200 are physically remote from and independently operated from the ticket holder and dispenser 300, the ticket activator 400, the first ticket image provider 500, the ticket revealer 600, the second ticket imager provider 700, the ticket validator 800, and the revealed ticket storer 900.

In this illustrated example embodiment, the ticket holder and dispenser 300, the ticket activator 400, the first ticket image provider 500, the ticket revealer 600, the second ticket imager provider 700, the ticket validator 800, and the revealed ticket storer 900 are described as separate components for explanation purposes. In various embodiments, certain combinations of these components can be combined into one apparatus. In various embodiments, the ticket activator 400, the first ticket image provider 500, the ticket revealer 600, the second ticket imager provider 700, the ticket validator 800, and the revealed ticket storer 900 are combined into one connected apparatus. In various embodiments, the ticket activator 400, the first ticket image provider 500, the ticket revealer 600, the second ticket imager provider 700, and the ticket validator 800 are combined into one connected apparatus (such as an automatic reveal and validation (“ARV”) apparatus). In various embodiments: (1) the ticket activator 400 and the first ticket image provider 500 are combined into a first apparatus; and (2) the second ticket imager provider 700 and the ticket validator 800 are combined into a second apparatus. Other combinations are contemplated and within the scope of the present disclosure. In various embodiments, certain elements of combined components (such as the processors, memory devices, data communication interfaces, actuators, and other operational and/or control components) can be integrated with each other and/or omitted to avoid duplication.

In this example embodiment, the ticket holder and dispenser 300, the ticket activator 400, the first ticket image provider 500, the ticket revealer 600, the second ticket imager provider 700, the ticket validator 800, and the revealed ticket storer 900 are each configured to provide and/or receive a ticket from a ticket outlet to a ticket inlet of another component, such as but not limited to as described below. For example, a ticket outlet of the ticket holder and dispenser 300 provides the dispensed ticket to a ticket inlet of the ticket activator 400. In various embodiments, a ticket outlet is configured to provide the ticket directly to the ticket inlet. In various embodiments, the auto-reveal system 10 includes additional ticket actuators (not shown) that move the tickets from the ticket outlet to the ticket inlet for one or more of the components.

In this example embodiment, one instance of these components is described for brevity but various other embodiments include multiple instances of certain of these components. For example, in various embodiments, the scratch-off instant lottery ticket auto-reveal system 10 can include a plurality of ticket holder and dispensers. In various embodiments, these plurality of ticket holder and dispensers are located in a same location. In various embodiments, each ticket holder and dispenser is associated with one, two, or more other components. In some such embodiments, one ticket holder and dispenser is associated with two or more different ticket activators. In some such embodiments, the different ticket activators can have different ticket size restrictions.

In this example embodiment, each instant lottery ticket has a physical substrate and includes: (1) a predefined scratch-off area on the front surface on the substrate; (2) variable lottery game symbols printed on the predefined scratch-off area of the substrate; (3) a validation identifier (or validation barcode associated with the validation identifier) printed on the predefined scratch-off area of the substrate; (4) a SOC on the substrate that cover the variable lottery game symbols, the validation identifier, and the predefined scratch-off area; and (5) variable instant lottery ticket information printed on the front surface and/or back surface of the substrate. For each instant lottery ticket, the instant lottery ticket information includes a ticket identifier (or ticket barcode associated with the ticket identifier) that identifies that instant lottery ticket and is not covered by the SOC. In this example embodiment, the ticket identifier includes a twelve-digit numeric code printed as a barcode. For each instant lottery ticket, the validation identifier enables validation of the instant lottery ticket and thus redemption of the instant lottery ticket of the instant lottery ticket is a winning instant lottery ticket. In this example embodiment, the validation identifier is a twelve-digit numeric code printed as a barcode and is different from the ticket identifier. In various embodiments, the instant lottery ticket information includes a game identifier (“game ID”) that indicates a game type for the instant lottery ticket. In some embodiments, the ticket identifier includes the game ID.

### Example State Lottery System

Various states (or other legal jurisdictions) operate a lottery system for instant lottery tickets that can be purchased within that state (e.g., by state residents or visitors to the state). Employees of the state lottery system select and order instant lottery tickets from one or more lottery ticket manufacturers. Once ordered, the selected instant lottery tickets are shipped in respective packs (as described above) from the manufacturers to a secure location of the state lottery system. In various embodiments, as mentioned above, certain components of the scratch-off instant lottery ticket auto-reveal system 10 are located at the secure location. Various systems that enable a state lottery system to order instant lottery tickets exists and thus are not described herein for brevity.

In this example embodiment, the ticket holder and dispenser 300, the ticket activator 400, the first ticket image provider 500, the ticket revealer 600, the second ticket imager provider 700, the ticket validator 800, and the revealed ticket storer 900 are located at the secure location that is controlled by the state lottery system or an operating agent or contractor thereof.

At the secure location, the packs of instant lottery tickets are each loaded into a different respective ticket drawers of the ticket holder and dispenser 300 (such as described below). Before, during, or after the packs of tickets are loaded, data about which tickets have been loaded into which ticket drawers of the ticket holder and dispenser is determined and stored. As tickets are purchased, the data is updated to reflect currently remaining tickets within the ticket drawers of the ticket holder and dispenser 300, for example, based on an empty dispenser notice received from the ticket holder and dispenser when that dispenser has an empty ticket drawer.

For the purchase of an instant lottery ticket, a purchaser can employ a purchaser electronic device that receives available ticket data indicating which tickets are available from the ticket holder and dispenser 300. In various embodiments, the available ticket data for each ticket can include actual or graphical image data associated with that ticket, enabling the purchaser electronic device to display an image associated with the ticket to the purchaser. In various embodiments, the electronic ticket purchasing system 100 can send the image data to the purchaser electronic device without the need for scanning or capturing an image of the ticket by the auto-reveal system 10 prior to the purchase of that ticket. For example, the image data can include previously stored image data of that ticket (such as image data received from the ticket manufacturer), a default image associated with that ticket (such as a default image for all tickets associated with a particular instant ticket game type), or an augmented image associated with that ticket (such as the default image augmented to include a ticket identifier or other ticket information specific to that ticket).

### Example Electronic Ticket Purchasing System

The electronic ticket purchasing system 100 is generally configured to receive and store available instant lottery ticket data that relates to a plurality of different instant lottery tickets that are available for purchase via the scratch-off instant lottery ticket auto-reveal system 10 (such as described above).

The electronic ticket purchasing system 100 is generally configured to enable a purchaser to use a purchaser electronic device (“PED”) with a purchaser application to: (1) see a display of indications of a plurality of different instant lottery tickets available for purchase that are stored in the ticket holder and dispenser 300; (2) select one of the different instant lottery tickets from the plurality of different instant lottery tickets; and (3) purchase the selected instant lottery ticket.

The electronic ticket purchasing system 100 is generally configured to send purchased instant lottery ticket data 110 to the lottery central system 200. In various embodiments, the purchased instant lottery ticket data 110 is associated with an order for an instant lottery ticket. In other words, the purchased instant lottery ticket data 110 indicates a game type for an instant lottery ticket that the purchaser wishes to purchase. In various embodiments, the order is identifiable by an order identifier and includes purchased instant lottery ticket data 110 for one, two, or more instant lottery tickets.

In one example embodiment, the electronic ticket purchasing system 100 includes the PED with the purchaser application (not shown), which can be any suitable device such as an electronic smartphone, an electronic tablet, an application server, or other suitable electronic computing device with suitable data communication, user input, and display functions. In various embodiments, the PED includes a personal electronic device associated with the purchaser. In various embodiments, the PED includes an application server or web server associated with an operator of the lottery central system 200.

The PED includes a processor (not shown) and a memory device (not shown) storing instructions that when executed by the processor cause and/or configure the processor to provide functionality as described herein. In various embodiments, all or a portion of the functionality of the purchaser application can be implemented using instructions stored in the memory device of the PED, application-specific integrated circuits, or other suitable hardware.

In various embodiments, the purchaser application displays indications of the plurality of different instant lottery tickets available for purchase, such as instant lottery tickets available from the ticket holder and dispenser 300.

In various embodiments, the purchaser application receives available ticket data from the lottery central system 200 (or via a lottery API gateway 210, described below).

In various embodiments, the purchaser application receives available ticket data from the ticket holder and dispenser 300 or another suitable entity.

In various embodiments, the available ticket data includes: (1) game types of the different instant lottery tickets available for purchase from the ticket holder and dispenser 300; (2) respective purchase prices of the tickets; (3) potential awards associated with the tickets; (4) image data associated with the tickets; (5) purchase restrictions associated with the tickets (e.g., geographic and/or jurisdictional restrictions); and/or (6) other suitable information associated with the tickets.

In various embodiments, the purchaser application displays the indications of the instant lottery tickets based on the available ticket data.

In various embodiments, the purchaser application is configured to display a subset of the different instant lottery tickets available based on preference data associated with and/or provided by the purchaser. The preference data can include, for example, a maximum purchase price, a minimum purchase price, previously purchased ticket information, or other suitable information.

In various embodiments, the purchaser application enables the purchaser to input a selection of a game type for an instant lottery ticket that the purchaser wishes to purchase and thus play (such as by interacting with a graphical user interface, scanning a new or previously used instant lottery ticket, or identifying a previously purchased instant lottery ticket). In various embodiments, the game type is associated with a game identifier (“game ID”) for the instant lottery ticket that the purchaser wishes to purchase.

The purchaser application functions on the PED to cause the PED to generate purchased instant lottery ticket data 110. In various embodiments, the purchased instant lottery ticket data 110 includes: (1) a player identifier (“player ID”) that uniquely identifies the purchaser; and (2) the game ID that indicates the purchaser's selected game type. In various embodiments, the player identifier includes or is associated with a purchaser digital signature for the purchaser that is generated using a purchaser cryptographic function and purchaser identifying information for the purchaser. The purchaser digital signature can include a data structure, data file, data bit sequence, data token, and/or other suitable digital identifier(s) that does not by itself/themself uniquely identify the purchaser, but can be used to uniquely identify the purchaser using a suitable cryptographic function (such as by re-generating the purchaser digital signature using the purchaser identifying information known by the purchaser). In various embodiments, the purchaser cryptographic function includes a hash function, keyed hash function, encryption function, and/or other suitable cryptographic function.

In various embodiments, the PED sends the purchased instant lottery ticket data 110 to the lottery central system 200. In various embodiments, The PED employs a lottery application programming interface (API) gateway 210 such as described below to send the purchased instant lottery ticket data 110 to the lottery central system 200.

In various embodiments, the electronic ticket purchasing system 100 includes a third party server (not shown) that provides a third party service. The third party service enables purchasers to remotely electronically purchase instant lottery tickets.

In various embodiments, the purchaser application includes a third party mobile application that is operable with the third party service. The third party mobile application functions to create the purchased instant lottery ticket data 110 and causes the player electronic device to send the purchased instant lottery ticket data 110 to the third party server via a suitable data network.

In various embodiments, the third party server sends the purchased instant lottery ticket data 110 to the lottery central system 200 (e.g., directly, or via the lottery API gateway 210).

In various embodiments, the third party server includes the lottery API gateway 210.

In various embodiments, the ticket activator 400, the first ticket image provider 500, the ticket revealer 600, the second ticket imager provider 700, the ticket validator 800, and the revealed ticket storer 900 can be located at a third party processing center.

In various embodiments, the purchaser application is configured to enable a purchaser to: (1) employ the purchaser application on the PED to set up a purchaser account identified by the player identifier (such as with a third party service provided by a third party server, not shown); (2) deposit funds to the purchaser account (e.g., from a bank account, from an instant lottery ticket award account); (3) withdraw funds from the purchaser account; (4) use funds in the purchaser account to purchase an instant lottery ticket; and/or (5) perform other suitable instant lottery ticket activities.

In various embodiments, the electronic ticket purchasing system 100 is configured to display image data associated with instant lottery tickets, such as available instant lottery tickets, purchased instant lottery tickets, and/or winning instant lottery tickets. In various embodiments, the PED is configured to display an image of an instant lottery ticket to the purchaser based on the image data.

In various embodiments, the image data includes: (1) previously stored image data of that ticket (such as image data received from the ticket manufacturer); (2) a default image associated with that ticket (such as a default image for all tickets associated with a particular instant ticket game type); (3) an augmented image associated with that ticket (such as the default image augmented to include a ticket identifier or other ticket information specific to that ticket); (4) image data associated with that ticket captured by the first ticket image provider 500 (e.g., with the SOC in-tact); (5) image data associated with that ticket captured by the second ticket image provider 700 (e.g., with the SOC removed); and/or (6) other suitable image data.

In various embodiments, the electronic ticket purchasing system 100 is configured to display an award notification associated with a winning instant lottery ticket. In some embodiments, the PED displays the award notification. The award notification includes: (1) an award tier associated with the instant lottery ticket; (2) an award amount associated with the instant lottery ticket; and/or (3) other suitable information. In various embodiments, the PED displays the award notification and the image data associated with the winning lottery ticket (e.g., image data captured by the second ticket image provider 700 with the SOC removed).

### Example Lottery Central System

The lottery central system 200 is configured to: (1) process purchased instant lottery ticket data for a purchased instant lottery ticket; (2) identify a ticket holder and dispenser 300 to dispense the purchased instant lottery ticket; (3) send an order for the purchased instant lottery ticket to the identified ticket holder and dispenser 300; (4) identify other components (such as a ticket activator 400, the first ticket image provider 500, the ticket revealer 600, the second ticket imager provider 700, the ticket validator 800, and/or the revealed ticket storer 900) for the dispensed ticket; (5) receive a ticket identifier associated with the dispensed ticket from the ticket activator 400; (6) activate and assign the dispensed ticket based on the ticket identifier (such as associating the dispensed ticket with the purchaser of that ticket); (7) receive a first ticket image of the dispensed ticket with the SOC thereof in-tact (and make that image available to the PED of the purchaser of the ticket); (8) receive a second ticket image of the dispensed ticket with the SOC removed (and make that image available to the PED of the purchaser of the ticket); (9) validate the dispensed ticket; (10) determine whether an instant lottery ticket is a winning ticket, and if so the award amount; (11) provide the award amount to the electronic ticket purchasing system 100 (e.g., for display by the PED); (12) provide the first ticket image and/or the second ticket image to the electronic ticket purchasing system 100 (e.g., for display by the PED); and/or (13) provide other suitable instant lottery ticket functionality.

The lottery central system 200 includes a processor (not shown), a memory device (not shown), and a data communication interface (not shown). The memory device stores instructions that when executed by the processor cause and/or configure the processor to provide functionality as described herein. In various embodiments, all or a portion of the functionality of the lottery central system 200 can be implemented using instructions stored in the memory device of the lottery central system 200, application-specific integrated circuits, or other suitable hardware.

The data communication interface is configured to enable secure data communications between the processor and other components of the scratch-off instant lottery ticket auto-reveal system 10. In various embodiments, the data communication interface includes a wired network adapter (e.g., Ethernet adapter), a wireless network adapter (e.g., Wi-Fi adapter and/or cellular data adapter), a direct cable connection (e.g., USB, SATA, or other wired connection), and/or other suitable data communication interface.

In various embodiments, the lottery central system 200 is associated with the lottery API gateway 210. In various embodiments, the lottery API gateway 210 includes a server that hosts a suitable application programming interface (API) for secure communication. The lottery API gateway 210 enables communication between the lottery central system 200 and other suitable devices, such as the electronic ticket purchasing system 100, the ticket holder and dispenser 300, the ticket activator 400, the first ticket image provider 500, the second ticket image provider 700, the ticket validator 800, and/or the revealed ticket storer 900.

The lottery central system 200 tracks and/or stores dispenser ticket supply data for instant lottery tickets. In various embodiments, the lottery central system 200 receives the dispenser ticket supply data from one, two, or more instances of the lottery ticket holder and dispensers 300. In various embodiments, the dispenser ticket supply data includes, for each game type of instant lottery tickets available for purchase at ticket holder and dispenser(s) 300: (1) the game ID for that game type; (2) dispenser identifier(s) that indicate which ticket holder and dispenser 300 is available to dispense instant lottery tickets of that game type; (3) a purchase price of the available different instant lottery tickets; (4) potential awards associated with the available different instant lottery tickets; (5) purchase restrictions associated with the available different instant lottery tickets (e.g., geographic and/or jurisdictional restrictions); (6) ticket size data associated with the instant lottery ticket; and/or (7) other suitable information associated with the different instant lottery tickets.

In various embodiments, the ticket size data includes: (1) a size indication associated with the instant lottery ticket (such as indicating a length and a width of the instant lottery ticket); (2) a size indication of the predefined scratch-off area on the instant lottery ticket (such as indicating a length and a width of the predefined scratch-off area); (3) a location indication of the predefined scratch-off area on the instant lottery ticket (such as indicating where the predefined scratch-off area is located on the substrate); and/or other (4) suitable size information.

In various embodiments, the lottery central system 200 employs a coordinate system with a common reference point to define the size of the instant lottery ticket, the size of the predefined scratch-off area, and/or the location of the predefined scratch-off area. The common reference point can include a predefined corner of the instant lottery ticket (e.g., an upper left corner, a lower left corner), a center of the instant lottery ticket, a location of a barcode or image printed on the instant lottery ticket, or other suitable reference point. The size indications can include a length value and a width value (e.g., 3 inches by 5 inches), a start coordinate and an end coordinate, a size identifier associated with one of a plurality of predetermined ticket sizes (e.g., a regular-size ticket, a double-size ticket, or a triple-size ticket), or any other suitable size indication. The location can include a start coordinate, an end coordinate, a location identifier associated with one of a plurality of predetermined locations, or other suitable location indication.

In various embodiments, the lottery central system 200 tracks and/or stores ticket size restrictions for the ticket holder and dispenser 300, the ticket activator 400, the first ticket image provider 500, the ticket revealer 600, the second ticket imager provider 700, and/or the ticket validator 800. The ticket size restrictions can include a maximum ticket size, a minimum ticket size, a maximum predefined scratch-off area size, a minimum predefined scratch-off area size, a predefined scratch-off area location restriction, or other suitable restrictions. In various embodiments, the lottery central system 200 employs the ticket size restrictions to identify the ticket holder and dispenser 300 to dispense the purchased instant lottery ticket. In various embodiments, the lottery central system 200 employs the ticket size restrictions to identify one or more of the ticket activator 400, the first ticket image provider 500, the ticket revealer 600, the second ticket imager provider 700, the ticket validator 800, and/or the revealed ticket storer 900 for the dispensed ticket. In some embodiments, the system 10 employs the ticket size restrictions to ensure that the dispensed ticket can be processed by the ticket activator 400, the first ticket image provider 500, the ticket revealer 600, the second ticket imager provider 700, the ticket validator 800, and the revealed ticket storer 900.

In various embodiments, the lottery central system 200 tracks and/or stores ticket assignment data for instant lottery tickets. In various embodiments, the ticket assignment data includes, for each instant lottery ticket: (1) a ticket identifier for that instant lottery ticket; (2) a game ID for that instant lottery ticket; (3) a player ID associated with that instant lottery ticket (such as identifying a purchaser or owner of that ticket); (4) a purchase date and time for that instant lottery ticket; (5) order information for an order for that instant lottery ticket; and/or (6) other suitable instant lottery ticket information. In various embodiments, the order information includes an order ID that identifies a particular order by a purchaser for one or more instant lottery tickets. In various embodiments, the lottery central system 200 updates the ticket assignment data to include image data associated with instant lottery tickets. In various embodiments, the image data includes: (1) previously stored image data of that ticket (such as image data received from the ticket manufacturer); (2) a default image associated with that ticket (such as a default image for all tickets associated with a particular instant ticket game type); (3) an augmented image associated with that ticket (such as the default image augmented to include a ticket identifier or other ticket information specific to that ticket); (4) image data associated with that ticket captured by the first ticket image provider 500 (e.g., with the SOC in-tact); (5) image data associated with that ticket captured by the second ticket image provider 700 (e.g., with the SOC removed); and/or (6) other suitable image data.

In various embodiments, the lottery central system 200 determines an award tier identifier for an instant lottery ticket. The award tier identifier indicates one of a plurality of award tiers associated with the instant lottery ticket. In this example embodiment, the plurality of award tiers include: (1) a non-winner tier for instant lottery tickets with no associated award; (2) a low tier for instant lottery tickets associated with an award under $60; (3) a mid tier for instant lottery tickets associated with an award between $60 and $600; and (4) a high tier for instant lottery tickets associated with an award greater than $600. In various embodiments, the lottery central system 200 employs a validation identifier associated with an instant lottery ticket to determine the award tier identifier.

### Example Ticket Holder and Dispenser

The ticket holder and dispenser 300 is configured to: (1) securely hold a plurality of instant lottery tickets; (2) receive an order for a purchased instant lottery ticket; and (3) dispense the purchased instant lottery ticket from a ticket outlet based on the order.

In various embodiments, the ticket holder and dispenser 300 holds multiple instant lottery tickets for a same game type.

In various embodiments, the ticket holder and dispenser 300 holds instant lottery tickets for different game types.

In various embodiments, the lottery ticket holder and dispenser 300 includes a housing, ticket drawers supported by the housing, one or more ticket bursters positioned in the housing, a processor (not shown) supported by the housing, a memory device (not shown) supported by the housing, and a data communication interface (not shown) supported by the housing. In various embodiments, the lottery ticket holder and dispenser 300 includes, or is associated with, a barcode scanner or other suitable image capture device.

The housing defines a ticket outlet (not shown) through which the ticket holder and dispenser 300 is configured to provide a dispensed ticket to the ticket activator 400, and a ticket movement path (not shown) extending from the ticket drawers to the ticket outlet and through which the dispensed ticket is moved through the lottery ticket holder and dispenser 300. In various embodiments, the lottery ticket holder and dispenser 300 includes a plurality of ticket engagers (not shown), such as rollers, actuators, and/or conveyors configured to move the dispensed ticket through the ticket movement path.

The ticket drawers are each configured to store instant lottery tickets, such as a pack of instant lottery tickets. The ticket drawers are each configured to feed a purchased instant lottery ticket to an associated ticket burster, or enable the ticket burster to cause the ticket drawer to feed the ticket into the ticket burster. The ticket burster is configured to separate the purchased instant lottery ticket from the pack of tickets and dispense the purchased instant lottery ticket.

The memory device stores instructions that when executed by the processor cause and/or configure the processor to provide functionality as described herein. In various embodiments, all or a portion of the functionality of the ticket holder and dispenser 300 can be implemented using instructions stored in the memory device of the ticket holder and dispenser 300, application-specific integrated circuits, and/or other suitable hardware.

The data communication interface is configured to enable secure data communications between the processor and other components of the scratch-off instant lottery ticket auto-reveal system 10. In various embodiments, the data communication interface includes a wired network adapter (e.g., Ethernet adapter), a wireless network adapter (e.g., Wi-Fi adapter and/or cellular data adapter), a direct cable connection (e.g., USB, SATA, or other wired connection), and/or other suitable data communication interface.

The ticket holder and dispenser 300 is configured to receive instant lottery tickets, such as a pack of instant lottery tickets, for storage in the ticket drawers. In various embodiments, a human ticket processing clerk loads pack(s) or instant lottery tickets into the lottery ticket drawers. In various embodiments, the ticket holder and dispenser 300 stores instant lottery tickets from multiple different manufacturers of instant lottery tickets. In various embodiments, multiple ticket holder and dispensers are located within a secure location, such as the secure location of the state lottery system described above.

In various embodiments, the ticket holder and dispenser 300 tracks and/or stores dispenser ticket supply data (described above) for instant lottery tickets that have been loaded in the ticket drawers. The dispenser ticket supply data can include the instant lottery ticket information printed on the instant lottery tickets (described above), ticket information printed on the pack of instant lottery tickets (e.g., a pack identifier that uniquely identifies the pack), or other suitable ticket information. In various embodiments, the ticket holder and dispenser 300 employs the barcode scanner (or image capture device) to obtain the dispenser ticket supply data from the instant lottery ticket(s) and/or pack(s). In various embodiments, the ticket holder and dispenser 300 partially dispenses a ticket of a pack to scan the ticket information of that ticket without bursting the ticket from the pack. The ticket holder and dispenser 300 then retracts the ticket so that the ticket is available for purchase.

In various embodiments, the ticket holder and dispenser 300 is configured to provide the dispenser ticket supply data to the lottery central system 200 and/or the lottery API gateway 210.

In various embodiments, the ticket holder and dispenser 300 is configured to receive the game ID (i.e., from the purchased instant lottery ticket data 110) from the lottery central system 200 and dispense an instant lottery ticket based on the game ID. In various embodiments, the ticket holder and dispenser 300 is configured to employ the game ID to identify a movable ticket burster, a ticket drawer column, and/or a ticket drawer for dispensing the instant lottery ticket such as described below.

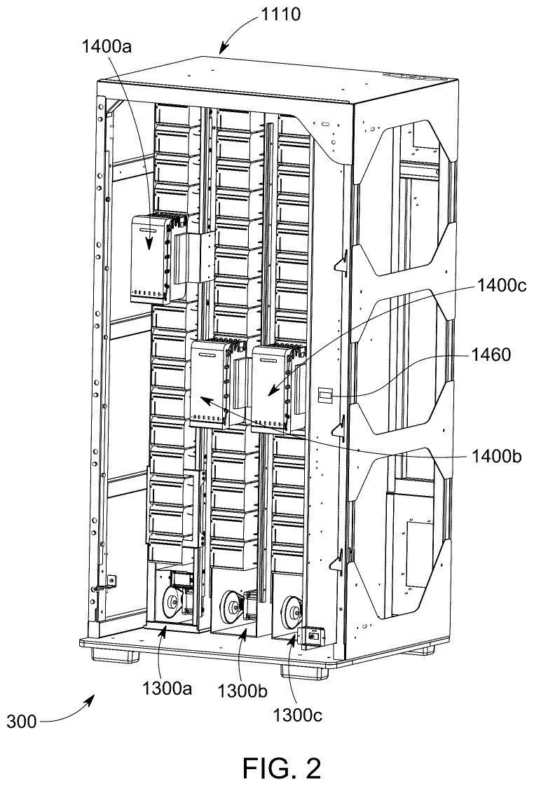

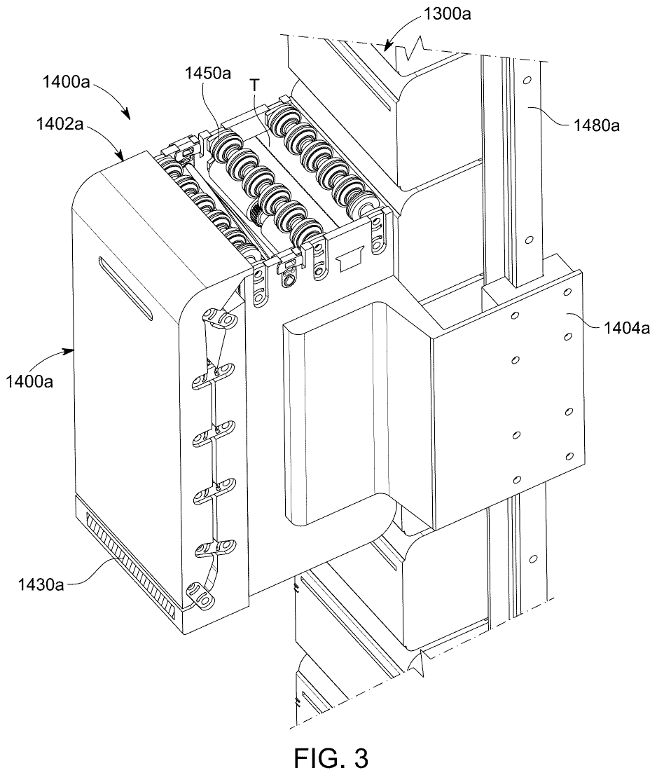

In one illustrated example embodiment shown in FIGS. 2 and 3, the lottery ticket holder and dispenser 300 includes: (a) a machine housing 1110; (b) three ticket drawer columns 1300a, 1300b, and 1300c positioned in and supported by the machine housing 1110; and (c) three separate and independently movable ticket bursters 1400a, 1400b, and 1400c positioned in the machine housing 1110 and supported by burster supports 1404a positioned in and supported by the machine housing 1110. The quantity of ticket drawer columns and associated movable ticket bursters can vary in accordance with the present disclosure.

The ticket holder and dispenser 300 includes various other components that are conventional in the industry and/or that would be readily apparent to those of ordinary skill in the art. For example, the ticket holder and dispenser 300 can include various electronic components (not shown) some of which can be contained in an electronic component holder (not shown) positioned in and supported by the machine housing 1110. The electronic components can form part of the control system for the ticket holder and dispenser 300. Various electronic components can also be positioned in the machine housing 1110 outside of the electrical component holder. The electronic components can include one or more controllers 360 that control(s) the operation of the ticket holder and dispenser 300 including the movable ticket bursters 1400a, 1400b, and 1400c as further discussed herein to facilitate the dispensing of each requested instant lottery ticket. The controller(s) 360 can be any suitable type of controller (such as a programmable logic controller) that includes any suitable processing device(s) (such as a microprocessor, a microcontroller-based platform, an integrated circuit, or an application-specific integrated circuit) and any suitable memory device(s) (such as random access memory, read-only memory, or flash memory). The memory device(s) stores instructions executable by the processing device(s) to control operation of the ticket holder and dispenser 300.

In this illustrated example embodiment, the machine housing 1110 includes suitable vertically extending supports 1480a configured to hold and support the respective ticket drawer columns 1300a, 1300b, and 1300c. The machine housing 1110 can be alternatively configured in accordance with the present disclosure.

Each of the ticket drawer columns 1300a, 1300b, and 1300c are identical in this example embodiment. For brevity, only ticket drawer column 1300a is described herein. Likewise, the three movable ticket bursters 1400a, 1400b, and 1400c are identical in this example embodiment. For brevity, only ticket burster 1400a associated with the ticket drawer column 1300a is described herein.

Ticket drawer column 1300a includes a series of aligned ticket drawers (not individually labeled) that are vertically stacked in the column. Each of the ticket drawers is configured to hold one or more packs of lottery tickets such as instant lottery tickets for selection by the purchasers and dispensing by the ticket holder and dispenser 300. The ticket drawers can vary in quantity, size, and shape depending upon the particular size of the ticket holder and dispenser 300 and the quantity, size, and shapes of the lottery tickets that the ticket holder and dispenser 300 can or will dispense. In various embodiments, the different ticket drawers can hold different lottery ticket packs for different lottery games (or game types), but it should be appreciated that two or more ticket drawers can hold the same type of lottery tickets. In various embodiments, each of the ticket drawers is configured to feed each instant lottery ticket held by that ticket drawer into the associated ticket burster 1400a when the ticket burster 1400a is moved into alignment with such ticket drawer for receipt, bursting, and dispensing of that lottery ticket. Bursting of the lottery ticket is the industry term for separating a lottery ticket from a pack of lottery tickets held in a ticket drawer. In this illustrated embodiment, the ticket drawers do not burst the lottery tickets and do not include any mechanisms for bursting the lottery tickets. Rather, in this illustrated embodiment, the moveable ticket burster 1400a is configured to receive and burst the lottery tickets fed by the lottery ticket drawers of the ticket drawer column 1300a into the ticket burster 1400a.

The movable ticket burster 1400a is supported by one or more burster supporters (such as burster supporter 1480a). The burster supporter(s) can be any suitable structure(s) that supports the ticket burster 1400a in a manner that enables the ticket burster 1400a to vertically move to any of a plurality of different ticket receipt positions that are associated with and in alignment with the respective ticket drawers of the ticket drawer column 1300a. The burster supporter(s) also support the ticket burster 1400a in a manner that enables the ticket burster 1400a to vertically move to a ticket dispense position. The ticket dispense position can be in alignment with a ticket outlet (not shown) of the ticket holder and dispenser 300, alignment with a ticket inlet of the ticket activator 400, and/or another suitable ticket dispense position of the ticket holder and dispenser 300.

The ticket holder and dispenser 300 includes one or more actuators (not shown) that control movement of the ticket burster 1400a under control of the controller 360 of the ticket holder and dispenser 300 and/or the controller (described below) of the ticket burster 1400a. In this example, an actuator (not labeled) is mounted at the bottom of the ticket drawer column 1300a and coupled to the ticket burster 1400a by suitable linkages (such as but not limited to pulleys and a drive belt (not labeled)). The actuator is configured to move the ticket burster 1400a under the control of the controller(s) in the vertical (e.g., up and down) directions. The movable ticket burster 1400a is thus moveable, via this actuator and linkages on the ticket burster supporter 1480a to different vertical locations including a plurality of the locations respectively associated and aligned with each of the ticket drawers of the ticket drawer column 1300a such that the ticket burster 1400a is positioned to receive one or more of the instant lottery tickets stored in each respective ticket drawers for obtaining and dispensing that instant lottery ticket into the ticket receptacle 1400 for the purchaser as requested by the purchaser.

As best shown in FIG. 3, the example movable ticket burster 1400a generally includes: (a) a burster housing 1402a; (b) one or more burster supporter connecters (such as burster support connector 1404a connecting the burster housing 1402a to the burster supporter 1480a); (c) one or more sensors (not labeled) supported by the burster housing 1402a; (d) a ticket cutter (not labeled) in and supported by the burster housing 1402a; (e) a plurality of ticket engagers 1450a supported by the burster housing 1402a; and (f) a burster controller (not shown). The ticket burster 1400a is generally configured to burst the perforations between an instant lottery ticket moved from a ticket drawer into the ticket burster 1400a and the next instant lottery ticket of the strip in the ticket drawer to enable the instant lottery ticket to be dispensed via the ticket dispensing outlet (not shown).

The burster controller (not shown) can be any suitable type of controller (such as a programmable logic controller) that includes any suitable processing device(s) (such as a microprocessor, a microcontroller-based platform, an integrated circuit, or an application-specific integrated circuit) and any suitable memory device(s) (such as random access memory, read-only memory, or flash memory). The memory device(s) stores instructions executable by the processing device(s) to control operation of the ticket burster. The burster controller can be hard wired or wirelessly connected to and in communication with the cutter, the ticket engagers 1450a, and any actuators on or associated with the ticket burster that cause the movement of the ticket burster. In such embodiments, the burster controller can be wirelessly connected to and in communication with the controller of the ticket holder and dispenser 300. In other embodiments, the ticket burster does not include a controller and is completely controlled by the controller of the ticket holder and dispenser 300. In such embodiments, the controller of the ticket holder and dispenser 300 can be wirelessly connected to and in communication with the cutter, the ticket engagers 1450a, and any actuators on the ticket burster or the burster supporter that cause the movement of the ticket burster. In various embodiments, the burster controller is not supported by the burster housing 1402a and is thus separate from the burster housing.

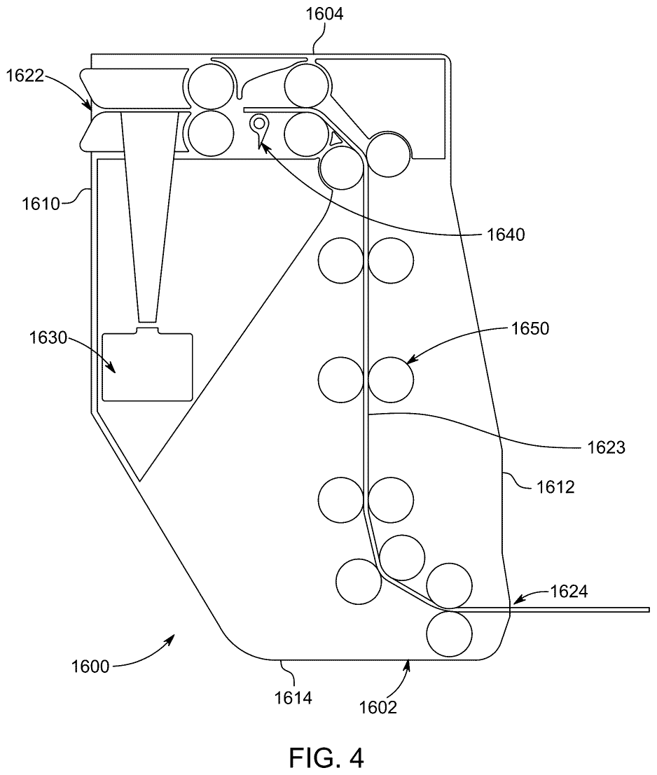

Turning to FIG. 4, an alternative ticket burster 1600 of another embodiment of the present disclosure is generally illustrated. In this example embodiment, like the above described ticket burster 1400a, this ticket burster 1600 generally includes: (a) a burster housing 1602; (b) one or more burster supporter connecters (not shown) connecting the burster housing 1602 to the burster supporter; (c) a code reader 1630 (such as a compact image sensor or barcode reader) supported by the burster housing 1602; (d) a ticket cutter 1640 supported by the burster housing 1602; (e) a plurality of ticket engagers 1650 supported by the burster housing 1602; and (f) a burster controller (not shown). In this example, the burster housing 1602 generally includes a top member 1604, spaced-apart side members 1606 and 1608, an inner member 1610, an outer member 1612, and a bottom member 1614. The burster housing 1602 also includes a plurality of internal members (not individually labeled) that define a ticket inlet 1622 through which the ticket burster 1600 is configured to receive an instant lottery ticket from a ticket drawer, a ticket outlet 1624 through which the ticket burster 1600 is configured to dispense the received instant lottery ticket, and a ticket movement path 1623 extending from the ticket inlet 1622 to the ticket outlet 1624 and through which the instant lottery ticket is moved through the ticket burster 1600. The burster housing 1602 and particularly the inner member 1610 thereof can define an opening for or part of the ticket inlet 1622. The burster housing 1602 and particularly the outer member 1612 thereof can define an opening for or part of the ticket outlet 1624.

In various alternative embodiments, the ticket holder and dispenser 300 of the present disclosure can have more than one ticket burster for one or more of the ticket drawer columns such that they can operate at the same time, or such that one or more ticket bursters are back-ups in case there is an issue with one of the other ticket bursters.

It should further be appreciated that the movable ticket burster of the present disclosure can replace the multiple stationary dispensing devices that are respectively mounted in front of each of the respective ticket drawers in various known instant lottery ticket holder and dispensers. It should also be appreciated that by eliminating the multiple stationary dispensing devices, a greater quantity of ticket drawers can be employed than in various known instant lottery ticket holder and dispensers.

### Example Ticket Activator

The ticket activator 400 is configured to: (1) receive a dispensed ticket from the ticket holder and dispenser 300; (2) scan instant lottery ticket information on the dispensed ticket to obtain scanned ticket data; (3) send a ticket identifier of the dispensed ticket to the lottery central system 200 to enable assignment of the dispensed ticket (such as by associating the dispensed ticket with the purchaser of that ticket); and (4) provide the dispensed ticket to the first ticket image provider 500.

In various embodiments, the ticket activator 400 enables activation of a pack of instant lottery tickets before such instant lottery tickets are loaded into the ticket holder and dispenser 300. In various embodiments, the ticket activator 400 is configured to: (1) scan instant lottery ticket information associated with the pack of instant lottery tickets to obtain scanned ticket data for the pack of instant lottery tickets and/or scanned ticket data for each instant lottery ticket within that pack; and (2) send the scanned ticket data to the lottery central system 200 to enable activation of the instant lottery tickets associated with that pack of instant lottery tickets. In various embodiments, activation of the pack of instant lottery tickets enables those tickets to be purchased, associated with a purchaser, and/or redeemed by a purchaser.

In various embodiments, the ticket activator 400 enables activation of a pack of instant lottery tickets after such instant lottery tickets are loaded into the ticket holder and dispenser 300, but before such tickets are dispensed from the ticket holder and dispenser 300. In various embodiments, the ticket activator 400 is configured to: (1) advance a first ticket of a pack of instant lottery tickets loaded into the ticket holder and dispenser 300 to enable scanning instant lottery ticket information of the first ticket without separating that first ticket from the pack of instant lottery tickets; (2) scan the instant lottery ticket information on the first ticket to obtain scanned ticket data; and (3) send a ticket identifier and/or pack identifier to the lottery central system 200 to enable activation of the pack of instant lottery tickets.

In various embodiments, the ticket activator 400 enables activation of the dispensed ticket when that ticket is received from the ticket holder and dispenser 300. In various embodiments, the ticket activator 400 is configured to send the ticket identifier of the dispensed ticket to the lottery central system 200 to enable activation of the dispensed ticket.

In various embodiments, the ticket activator 400 includes a housing 410, a processor 420 supported by the housing, a memory device 422 supported by the housing, a data communication interface 424 supported by the housing, and a barcode scanner 430 supported by the housing.

In various embodiments, the ticket activator 400 employs the barcode scanner 430 to scan the ticket identifier of the dispensed ticket. Specifically, the barcode scanner 430 scans the ticket barcode on the back surface of the dispensed ticket to obtain the ticket identifier. The dispensed ticket includes the SOC in-tact, but the ticket barcode is not covered by the SOC and can be scanned without removal of the SOC.

In various embodiments, the ticket activator 400 is configured to send the ticket identifier of the dispensed ticket to the lottery central system 200 to enable assignment of the dispensed ticket to the purchaser (e.g., by associating the ticket identifier with the purchaser and/or the order for the instant lottery ticket). Specifically, the dispensed ticket is assigned to the purchaser before the SOC is removed from the dispensed ticket. In various embodiments, the lottery central system 200 confirms a pack status of the pack of instant lottery tickets from which the dispensed ticket was obtained to ensure that the pack was properly loaded and/or activated.

In this example embodiment, the ticket identifier is a twelve-digit numeric code and is readily transmitted via the data communication interface 424, as compared to an image or video of the dispensed ticket which would be much larger than the ticket identifier. In various embodiments, the ticket activator 400 employs the lottery API gateway 210 to send the ticket identifier to the lottery central system 200.

In various embodiments, the ticket activator 400 is configured to send the ticket identifier of the dispensed ticket to a third party service. The third party service logs the ticket identifier with a player ID of the purchaser and/or an order identifier for the order for the dispensed ticket.

The housing 410 of the ticket activator 400 defines a ticket inlet 412 through which the ticket activator 400 is configured to receive the dispensed ticket, a ticket outlet 414 through which the ticket activator 400 is configured to provide the dispensed ticket to the first ticket image provider 500, and a ticket movement path 416 extending from the ticket inlet 412 to the ticket outlet 414 and through which the dispensed ticket is moved through the ticket activator 400. In various embodiments, the ticket activator 400 includes a plurality of ticket engagers 450, such as rollers, actuators, and/or conveyors configured to move the dispensed ticket through the ticket movement path 416.

The memory device 422 stores instructions that when executed by the processor 420 cause and/or configure the processor 420 to provide functionality as described herein. In various embodiments, all or a portion of the functionality of the ticket activator 400 can be implemented using instructions stored in the memory device 422 of the ticket activator 400, application-specific integrated circuits, and/or other suitable hardware.

The data communication interface 424 is configured to enable secure data communications between the processor 420 and other components of the scratch-off instant lottery ticket auto-reveal system 10. In various embodiments, the data communication interface 424 includes a wired network adapter (e.g., Ethernet adapter), a wireless network adapter (e.g., Wi-Fi adapter and/or cellular data adapter), a direct cable connection (e.g., USB, SATA, or other wired connection), and/or other suitable data communication interface.

In various embodiments, the ticket activator 400 is configured to receive the game ID of the purchased instant lottery ticket data 110 from the lottery central system 200. In various embodiments, the ticket activator 400 verifies that the game ID of the purchased instant lottery ticket data 110 matches a game ID of the dispensed ticket before sending the ticket identifier associated with the dispensed ticket to the lottery central system 200. In some such embodiments, the ticket activator 400 is configured to discard the dispensed ticket without activating the dispensed ticket when the game IDs do not match.

In various embodiments, the ticket burster functions as the ticket activator 400. In various such embodiments, the ticket burster that functions as the ticket activator 400 employs a barcode scanner to scan the ticket identifier of the dispensed ticket. Specifically, the barcode scanner scans the ticket barcode on the back surface of the dispensed ticket to obtain the ticket identifier. In various embodiments, the ticket burster that functions as the ticket activator 400 is configured to send the ticket identifier of the dispensed ticket to the lottery central system 200 to enable activation of the dispensed ticket and assignment of the dispensed ticket with the player who purchased that ticket.

### Example First Ticket Image Provider

The first ticket image provider 500 is configured to: (1) receive the dispensed ticket from the ticket activator 400 before the SOC has been removed from that dispensed ticket; (2) obtain first image data of the dispensed ticket before the SOC has been removed; (3) send the first image data to the lottery central system 200; and (4) provide the dispensed ticket to the ticket revealer 600.

In various embodiments, the first ticket image provider 500 includes a housing 510, a processor 520 supported by the housing, a memory device 522 supported by the housing, a data communication interface 524 supported by the housing, a first image capture device 530 supported by the housing, and a second image capture device 532 supported by the housing.

The housing 510 defines a ticket inlet 512 through which the first ticket image provider 500 is configured to receive the dispensed ticket, a ticket outlet 514 through which the first ticket image provider 500 is configured to provide the dispensed ticket to the ticket revealer 600, and a ticket movement path 516 extending from the ticket inlet 512 to the ticket outlet 514 and through which the dispensed ticket is moved through the first ticket image provider 500. In various embodiments, the first ticket image provider 500 includes a plurality of ticket engagers 550 such as rollers, actuators, and/or conveyors configured to move the dispensed ticket through the ticket movement path 516.

The memory device 522 stores instructions that when executed by the processor 520 cause and/or configure the processor 520 to provide functionality as described herein. In various embodiments, all or a portion of the functionality of the first ticket image provider 500 can be implemented using instructions stored in the memory device 522 of the first ticket image provider 500, application-specific integrated circuits, or other suitable hardware.

The data communication interface 524 is configured to enable secure data communications between the processor 520 and other components of the scratch-off instant lottery ticket auto-reveal system 10. In various embodiments, the data communication interface 524 includes a wired network adapter (e.g., Ethernet adapter), a wireless network adapter (e.g., Wi-Fi adapter and/or cellular data adapter), a direct cable connection (e.g., USB, SATA, or other wired connection), and/or other suitable data communication interface.

In various embodiments, the first image capture device 530 and the second image capture device 532 are configured to capture images of the dispensed ticket and create image data. In various embodiments, the first and second image capture devices 530 and 532 each include a charge coupled device (CCD) image sensor, an active pixel sensor, and/or other suitable digital image sensor.

The first image capture device 530 is configured to capture image data for the front surface of the dispensed ticket. The second image capture device 532 is configured to capture image data for the back surface of the dispensed ticket. For brevity, the image data for the front surface and the back surface of the dispensed ticket (i.e., with the SOC in-tact) are collectively referred to herein as first image data.

In various embodiments, the first image capture device 530 and the second image capture device 532 are configured to capture the first image data as still image(s) of the dispensed ticket.

In various embodiments, the first image capture device 530 and the second image capture device 532 can each include a simple digital camera, are not video cameras, or are not configured to capture video for the first ticket image provider 500. In such embodiments, the first image data is relatively small in size as compared to video data that might be captured by a video camera. In such embodiments, the first image data is readily transmitted via the data communication interface 524 (e.g., using less bandwidth, having a reduced transmission time, and using reduced processing resources).

In various embodiments, the second image capture device 532 is omitted and the first ticket image provider 500 is configured to employ the first image capture device 530 to capture the image data for the front surface and the image data for the back surface of the dispensed ticket. In various embodiments, the first ticket image provider 500 includes mirrors (not shown) or other reflective surfaces to enable the first image capture device 530 to capture the image data. In various embodiments, the first ticket image provider 500 includes additional actuators (not shown) that are configured to present both the front surface and the back surface of the dispensed ticket to the first image capture device 530, for example, by flipping the dispensed ticket over, moving and/or rotating the first image capture device 530, and/or moving the mirrors.

In various embodiments, the first ticket image provider 500 is configured to send the image data associated with the dispensed ticket to the lottery central system 200 through the data communication interface 524. In various embodiments, the first ticket image provider 500 employs the lottery API gateway 210 to send the first image data to the lottery central system 200.

### Example Ticket Revealer

The ticket revealer 600 is configured to: (1) receive the dispensed ticket from the first ticket image provider 500; (2) physically remove the SOC from the dispensed ticket to reveal the variable lottery game symbols and validation identifier of the dispensed ticket; and (3) provide the revealed ticket to the second ticket image provider 700.

In various embodiments, the ticket revealer 600 includes a housing 610, a processor 620 supported by the housing 610, a memory device 622 supported by the housing 610, a data communication interface 624 supported by the housing 610, and an SOC remover 630 supported by the housing 610. In various embodiments, the ticket revealer 600 includes an SOC fragment remover 632.

The housing 610 defines a ticket inlet 612 through which the ticket revealer 600 is configured to receive the dispensed ticket, a ticket outlet 614 through which the ticket revealer 600 is configured to provide the revealed ticket to the second ticket image provider 700, and a ticket movement path 616 extending from the ticket inlet 612 to the ticket outlet 614 and through which the dispensed ticket and revealed ticket is moved through the ticket revealer 600. In various embodiments, the ticket revealer 600 includes a plurality of ticket engagers 650, such as but not limited to rollers, actuators, and/or conveyors configured to move the dispensed ticket and then the revealed ticket through the ticket movement path 616.

The memory device 622 stores instructions that when executed by the processor 620 cause and/or configure the processor 620 to provide functionality as described herein. In various embodiments, all or a portion of the functionality of the ticket revealer 600 can be implemented using instructions stored in the memory device 622 of the ticket revealer 600, application-specific integrated circuits, or other suitable hardware.

The data communication interface 624 is configured to enable secure data communications between the processor 620 and other components of the scratch-off instant lottery ticket auto-reveal system 10. In various embodiments, the data communication interface 624 includes a wired network adapter (e.g., Ethernet adapter), a wireless network adapter (e.g., Wi-Fi adapter and/or cellular data adapter), a direct cable connection (e.g., USB, SATA, or other wired connection), and/or other suitable data communication interface.

The SOC remover 630 is configured to physically remove all or a portion of the SOC on the dispensed ticket, such as by scratching, scraping, and/or brushing. After removal of the SOC of dispensed ticket, the dispensed ticket then becomes a revealed ticket as referred to herein.

In various other embodiments, the SOC remover 630 is configured to remove only a portion of the SOC on the dispensed ticket, such as a portion of the SOC that covers the validation barcode and/or validation identifier.

In various embodiments, the SOC remover 630 includes a mechanical remover, such as a scraper, brush, abrasive surface, and/or other suitable mechanical device. In various embodiments, the SOC remover 630 includes an actuator operable to cause the mechanical remover to engage the dispensed ticket. The actuator moves the mechanical remover relative to the dispensed ticket, such as but not limited to by rotating, oscillating, and/or spinning the mechanical remover and/or moving the dispensed ticket forward and backward along the ticket movement path 616, to cause the SOC to be removed from the dispensed ticket by the mechanical remover.

In various embodiments, the SOC fragment remover 632 is configured to remove residual fragments of the SOC from the revealed ticket, the SOC remover 630, the ticket engagers 650, and/or the ticket movement path 616. In various embodiments, the SOC fragment remover 632 includes but is not limited to a brush, vacuum, blower, and/or compressed air canister operable to sweep, vacuum, and/or blow the residual fragments. In various embodiments, the ticket revealer 600 employs the SOC fragment remover 632: (1) while the SOC remover 630 removes the SOC from the dispensed ticket; (2) after removal of the SOC has been completed; (3) after the revealed ticket has been moved along the ticket movement path 616 away from the mechanical remover; and/or (4) after the revealed ticket has been provided to the second ticket image provider 700.

In various embodiments, the ticket revealer 600 does not include a camera or other image capture device that captures images or video of the operation performed by the ticket revealer 600.

In various embodiments, the ticket revealer 600 prevents the residual fragments of the SOC from collecting on the camera and obscuring the captured images, which reduces maintenance and cleaning requirements for the auto-reveal system 10.

In various embodiments, the ticket revealer 600 is configured to process instant lottery tickets that are all of the same size.

In various embodiments, the ticket revealer 600 is configured to process instant lottery tickets that are of different sizes. In various embodiments, the ticket revealer 600 receives the ticket size data associated with the instant lottery ticket from the lottery central system 200. As described above, the ticket size data can include the size indication of the instant lottery ticket, the size indication of the predefined scratch-off area, and/or the location indication of the predefined scratch-off area. In various embodiments, the ticket revealer 600 employs the ticket size data to process the instant lottery tickets. In various embodiments, the ticket revealer 600 adjusts the plurality of ticket engagers 650 based on the ticket size data (e.g., to facilitate movement of the instant lottery ticket along the ticket movement path 616). In various embodiments, the ticket revealer 600 adjusts the SOC remover 630 based on the ticket size data (e.g., to facilitate removal of the SOC).

In various embodiments, the ticket revealer 600 is configured to process instant lottery tickets that have only one SOC.

In various embodiments, the ticket revealer 600 is configured to process instant lottery tickets that have multiple separate SOCs.

In various embodiments, the ticket revealer 600 is configured to process instant lottery tickets that have an SOC on only one side.

In various embodiments, the ticket revealer 600 is configured to process instant lottery tickets that have SOCs on both sides.

In various embodiments, a plurality of ticket revealers share a same SOC fragment remover 632, such as a shared vacuum system.

### Example Second Ticket Image Provider

The second ticket image provider 700 is configured to: (1) receive the revealed ticket (i.e., with the SOC removed) from the ticket revealer 600; (2) obtain second image data of the revealed ticket to the lottery central system 200, (3) send the second image data to the lottery central system 200; and (4) provide the revealed ticket to the ticket validator 800.

In various embodiments, the second ticket image provider 700 includes a housing 710, a processor 720 supported by the housing 710, a memory device 722 supported by the housing 710, a data communication interface 724 supported by the housing 710, and a first image capture device 730 supported by the housing 710. In various embodiments, the second ticket image provider 700 includes a second image capture device 732 supported by the housing 710.

The housing 710 defines a ticket inlet 712 through which the second ticket image provider 700 is configured to receive the revealed ticket, a ticket outlet 714 through which the second ticket image provider 700 is configured to provide the revealed ticket to the ticket validator 800, and a ticket movement path 716 extending from the ticket inlet 712 to the ticket outlet 714 and through which the revealed ticket is moved through the second ticket image provider 700. In various embodiments, the second ticket image provider 700 includes a plurality of ticket engagers 750, such as rollers, actuators, and/or conveyors configured to move the revealed ticket through the ticket movement path 716.

The memory device 722 stores instructions that when executed by the processor 720 cause and/or configure the processor 720 to provide functionality as described herein. In various embodiments, all or a portion of the functionality of the second ticket image provider 700 can be implemented using instructions stored in the memory device 722 of the second ticket image provider 700, application-specific integrated circuits, or other suitable hardware.

The data communication interface 724 is configured to enable secure data communications between the processor 720 and other components of the scratch-off instant lottery ticket auto-reveal system 10. In various embodiments, the data communication interface 724 includes a wired network adapter (e.g., Ethernet adapter), a wireless network adapter (e.g., Wi-Fi adapter and/or cellular data adapter), a direct cable connection (e.g., USB, SATA, or other wired connection), and/or other suitable data communication interface.

In various embodiments, the first image capture device 730 and the second image capture device 732 are configured to capture images of the revealed ticket and create image data. In various embodiments, the first and second image capture devices 730 and 732 each include a charge coupled device (CCD) image sensor, an active pixel sensor, and/or another suitable digital image sensor.

The first image capture device 730 is configured to capture image data for the front surface of the revealed ticket. The second image capture device 732 is configured to capture image data for the back surface of the revealed ticket. For brevity, the image data for the front surface and the back surface of the revealed ticket (i.e., with the SOC removed) are collectively referred to herein as second image data or revealed ticket image data.

In various embodiments, the first image capture device 730 and the second image capture device 732 are configured to capture the second image data as still image(s) of the revealed ticket.

In various embodiment, the first image capture device 730 and the second image capture device 732 can each include a simple digital camera, are not video cameras, or are not configured to capture video for the second ticket image provider 700. In such embodiments, the second image data is relatively small in size as compared to video data that might be captured by a video camera. In such embodiments, the second image data is readily transmitted via the data communication interface 724 (e.g., using less bandwidth, having a reduced transmission time, and using reduced processing resources).

In various embodiments, the second image capture device 732 is omitted and the second ticket image provider 700 is configured to employ the first image capture device 730 to capture the image data for the front surface and the image data for the back surface of the revealed ticket. In various embodiments, the second ticket image provider 700 includes mirrors (not shown) or other reflective surfaces to enable the first image capture device 730 to capture the image data. In various embodiments, the second ticket image provider 700 includes additional actuators (not shown) that are configured to present both the front surface and the back surface of the revealed ticket to the first image capture device 730, for example, by flipping the revealed ticket over, moving and/or rotating the first image capture device 730, and/or moving the mirrors.

In various embodiments, the second ticket image provider 700 is configured to send the second image data associated with the revealed ticket to the lottery central system 200 through the data communication interface 724. In various embodiments, the second ticket image provider 700 employs the lottery API gateway 210 to send the second image data to the lottery central system 200.

In various embodiments, the second ticket image provider 700 is the same as the first ticket image provider 500. In other words, the auto-reveal system 10 can include two instances of the first ticket image provider 500, with the first instance providing the first image data before removal of the SOC and the second instance providing the second image data after the removal of the SOC.

In various embodiments, the second ticket image provider 700 is omitted and the first ticket image provider 500 provides both the first image data and the second image data. In various embodiments, the auto-reveal system 10 can include additional ticket actuators (not shown) that move the revealed ticket, for example, from the ticket revealer 600 back to the first ticket image provider 500. In various embodiments, auto-reveal system 10 is configured to move the revealed ticket backwards through the ticket movement path 516 (via the actuators 550) and/or the ticket movement path 616 (via the actuators 650) to enable the first ticket image provider 500 to capture the second image data.

In various embodiments, the first ticket image provider 500 is omitted and the second ticket image provider 700 provides both the first image data and the second image data. In various embodiments, the auto-reveal system 10 includes additional ticket actuators (not shown) that move the dispensed ticket, for example, from the ticket activator 400 to the second ticket image provider 700 and then back to the ticket revealer 600. In various embodiments, auto-reveal system 10 is configured to: (1) move the dispensed ticket forwards through the ticket movement path 616 (via the actuators 650) and the ticket movement path 716 (via the actuators 750) to enable the second ticket image provider 700 to capture the second image data; and (2) move the dispensed ticket backwards through the ticket movement path 716 (via the actuators 750) and the ticket movement path 616 (via the actuators 650) to enable the removal of the SOC.

### Example Ticket Validator

The ticket validator 800 is generally configured to: (1) receive the revealed ticket (i.e., the ticket with the SOC removed) from the second ticket image provider 700; (2) provide the validation identifier associated with the revealed ticket to the lottery central system 200 for validation of the revealed ticket; (3) receive the player ID associated with the revealed ticket from the lottery central system 200; (4) stamp the player ID onto the revealed ticket; (5) receive an award tier identifier associated with the revealed ticket; and (6) provide the revealed ticket and a secure storage bin identifier based on the award tier identifier to the revealed ticket storer 900.

In various embodiments, the ticket validator 800 includes a housing 810, a processor 820 supported by the housing 810, a memory device 822 supported by the housing 810, a data communication interface 824 supported by the housing 810, a barcode scanner 830 supported by the housing 810, and a ticket ownership labeling device 832 supported by the housing 810.

The housing 810 defines a ticket inlet 812 through which the ticket validator 800 is configured to receive the revealed ticket, a ticket outlet 814 through which the ticket validator 800 is configured to provide the revealed ticket to the revealed ticket storer 900, and a ticket movement path 816 extending from the ticket inlet 812 to the ticket outlet 814 and through which the revealed ticket is moved through the ticket validator 800. In various embodiments, the ticket validator 800 includes a plurality of ticket engagers 850, such as but not limited to rollers, actuators, and/or conveyors configured to move the revealed ticket through the ticket movement path 816.

The memory device 822 stores instructions that when executed by the processor cause and/or configure the processor 820 to provide functionality as described herein. In various embodiments, all or a portion of the functionality of the ticket validator 800 can be implemented using instructions stored in the memory device 822 of the ticket validator 800, application-specific integrated circuits, and/or other suitable hardware.

The data communication interface 824 is configured to enable secure data communications between the processor 820 and other components of the scratch-off instant lottery ticket auto-reveal system 10. In various embodiments, the data communication interface 824 includes a wired network adapter (e.g., Ethernet adapter), a wireless network adapter (e.g., Wi-Fi adapter and/or cellular data adapter), a direct cable connection (e.g., USB, SATA, or other wired connection), and/or other suitable data communication interface.

In various embodiments, the ticket validator 800 employs the barcode scanner 830 to obtain the validation identifier of the revealed ticket. Specifically, the barcode scanner 830 scans the validation barcode on the front surface of the revealed ticket to obtain the validation identifier. The validation identifier enables validation of the revealed ticket. After removal of the SOC by the ticket revealer 600, the validation barcode is scannable by the barcode scanner 830. In various other embodiments, the ticket validator 800 employs an image capture device (not shown) to capture an image of the validation barcode and performs image processing to obtain the validation identifier. In various embodiments, the ticket validator 800 receives all or a portion of the revealed ticket image data captured by the second ticket image provider 700 and performs image processing to obtain the validation identifier.

In various embodiments, the ticket validator 800 is configured to send the validation identifier to the lottery central system 200 to enable validation of the revealed ticket. In this example embodiment, the validation identifier is a twelve-digit numeric code and is readily transmitted via the data communication interface 824, as compared to an image or video of the revealed ticket which would be much larger than the validation identifier. In various embodiments, the ticket validator 800 employs the lottery API gateway 210 to send the validation identifier to the lottery central system 200.

In various embodiments, the ticket ownership labeling device 832 includes a stamping device, a printer, or other suitable labeling device. The ticket ownership labeling device 832 is operable to imprint ticket ownership information onto the revealed ticket. In various embodiments, the ticket ownership labeling device imprints the player ID onto the revealed ticket. In various embodiments, the ticket validator 800 receives the ticket ownership information from the lottery central system 200, for example, in response to the validation identifier. In various embodiments, the ticket validator 800 receives the ticket ownership information from the electronic ticket purchasing system 100.

The ticket validator 800 is configured to receive the award tier identifier associated with the revealed ticket from the lottery central system 200, for example, in response to the validation identifier. In various embodiments, the ticket validator 800 is configured to assign a secure storage bin identifier to the revealed ticket based on the award tier identifier received from the lottery central system 200. In this example embodiment, the ticket validator 800 is operable to: (1) assign each revealed ticket associated with the non-winner tier to a non-winner bin; (2) assign each revealed ticket associated with the low tier to a low tier bin; (3) assign each revealed ticket associated with the mid tier to a mid tier bin; and (4) assign each revealed ticket associated with the high tier to a high tier bin.

In various embodiments, the ticket validator 800 is configured to send the secure storage bin identifier associated with the revealed ticket to the revealed ticket storer 900 (e.g., through the data communication interface). In various embodiments, the ticket validator 800 employs the lottery API gateway 210 to send the secure storage bin identifier to the revealed ticket storer 900.

In various embodiments, the ticket validator 800 is configured to assign each revealed ticket associated with the non-winner tier and the low tier to a short term retention bin. In these embodiments, the system 10 is configured to provide a payment for the award amount (i.e., for low tier tickets), then retain the non-winner tier tickets and low tier tickets for a short period of time (e.g., 10 or 30 days) before being discarded.

In various embodiments, the ticket validator 800 is configured to temporarily retain each revealed ticket that is associated with the mid tier or high tier. In various embodiments, the ticket validator 800 causes the ticket engagers 850 to mechanically secure the instant lottery ticket and prevent its removal until an authorized person (such as a ticket clerk) retrieves the instant lottery ticket (such as by employing a mechanical key and/or secure password at a management console to release the instant lottery ticket from the ticket engagers 850). Once removed from the ticket validator 800, the authorized person can physically transfer the instant lottery ticket to the purchaser, to a claim location, or other suitable location. In these embodiments, the revealed ticket storer 900 is bypassed by the authorized person.

In various such embodiments, the ticket validator 800 is part of the ticket revealer 600 and thus the ticket revealer 600 is configured to temporarily retain each revealed ticket that is associated with the mid tier or high tier until removed therefrom by the authorized person.

In various such embodiments, the ticket validator does not deliver the no award and low tier instant lottery tickets to the revealed ticket storer, but rather dispenses those tickets into a discarding bin configured to hold such tickets to be discarded. In such embodiments, all needed images and other information from those revealed instant lottery ticket have been obtained and such tickets do not need to be stored for later use.

In various embodiments, the ticket validator 800 is configured to retain each revealed ticket while the revealed ticket is being validated. In various embodiments, the ticket validator 800 causes the ticket engagers 850 to mechanically secure the instant lottery ticket and prevent its removal until the award tier identifier has been received from the central lottery system 200.

### Example Revealed Ticket Storer

The revealed ticket storer 900 is configured to: (1) receive the revealed ticket and the secure storage bin identifier from the ticket validator 800; (2) route the revealed ticket to a respective secure storage bin associated with the secure storage bin identifier; and (3) provide the secure storage bin identifier to the lottery central system 200.

In various embodiments, the revealed ticket storer 900 includes a housing 910, a processor 920 supported by the housing 910, a memory device 922 supported by the housing 910, a data communication interface 924 supported by the housing 910, a plurality of secure storage bins that are supported by the housing 910 and are each identifiable by a secure storage bin identifier, and a ticket routing device 930. In this example embodiment, the plurality of secure storage bins include bins 932a, 932b, 932c, and 932d and are collectively referred to herein as secure storage bins 932.

The housing 910 defines a ticket inlet 912 through which the revealed ticket storer 900 is configured to receive the revealed ticket and defines different ticket movement paths (not labeled) extending from the ticket inlet 912 to the plurality of secure storage bins 932 and through which the revealed ticket is moved through the revealed ticket storer 900. In various embodiments, the revealed ticket storer 900 includes a plurality of ticket engagers 950, such as rollers, actuators, and/or conveyors configured to move the dispensed ticket through the ticket movement paths.

The memory device 922 stores instructions that when executed by the processor 920 cause and/or configure the processor 920 to provide functionality as described herein. In various embodiments, all or a portion of the functionality of the revealed ticket storer 900 can be implemented using instructions stored in the memory device 922 of the revealed ticket storer 900, application-specific integrated circuits, and/or other suitable hardware.

The data communication interface 924 is configured to enable secure data communications between the processor 920 and other components of the scratch-off instant lottery ticket auto-reveal system 10. In various embodiments, the data communication interface 924 includes a wired network adapter (e.g., Ethernet adapter), a wireless network adapter (e.g., Wi-Fi adapter and/or cellular data adapter), a direct cable connection (e.g., USB, SATA, or other wired connection), and/or other suitable data communication interface.

The plurality of secure storage bins 932 are each configured to receive revealed tickets from the ticket inlet 912 and prevent unauthorized access to the revealed tickets. In various embodiments, each secure storage bin includes one or more lockable doors through which the revealed tickets can be removed by an authorized clerk (e.g., with a key for that lockable door). In various embodiments, the housing 910 of the revealed ticket storer 900 includes one or more lockable doors through which the revealed tickets (and/or the secure storage bins themselves) can be removed by an authorized clerk.

In various embodiments, each of the plurality of secure storage bins 932 include a removable container that holds the received revealed tickets, and which can be removed when full and replaced with an empty container.

In various embodiments, each of the plurality of secure storage bins 932 is associated with: (1) an award tier of a plurality of award tiers associated with instant lottery tickets; (2) an award tier identifier associated with the award tier of the plurality of award tiers; (3) redemption criteria for the instant lottery tickets (e.g., a location at which the ticket will be held for redemption by the purchaser), and/or (4) other suitable information associated with categorization and/or ranking of the tickets. In this example embodiment, the plurality of secure storage bins includes: (1) a non-winner storage bin 932a; (2) a low tier storage bin 932b; (3) a mid tier storage bin 932c; and (4) a high tier storage bin 932d.

In various embodiments, the ticket routing device 930 is configured to employ the ticket engagers 950 to route revealed tickets to one of the plurality of secure storage bins 932. In various embodiments, the ticket routing device 930 determines the secure storage bin based on the secure storage bin identifier received from the ticket validator 800. In various embodiments, the ticket routing device 930 receives the secure storage bin identifier from the lottery central system 200.

### Example Method of Operation

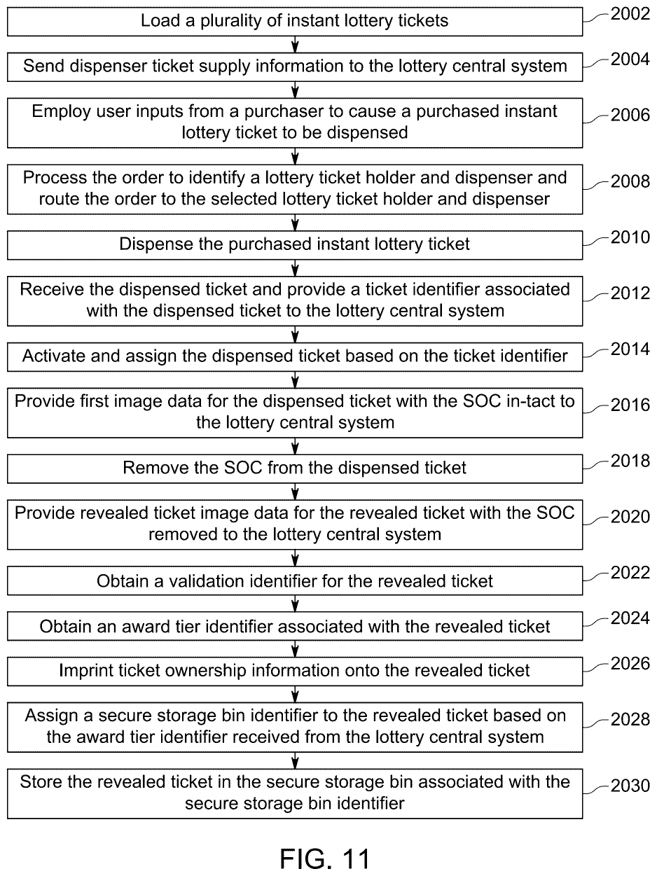

FIG. 11 illustrates an example method 2000 of operation of the auto-reveal system 10 with respect to an example instant lottery ticket.

The ticket holder and dispenser 300 is loaded with a plurality of different instant lottery tickets, as indicated at block 2002. In various embodiments, a ticket processing clerk loads instant lottery tickets and/or packs of instant lottery tickets into the lottery ticket drawers of the ticket holder and dispenser 300.

Based on the loaded instant lottery ticket(s) and/or pack(s), the ticket holder and dispenser 300 determines suitable dispenser ticket supply data, described above. In various embodiments, the ticket processing clerk employs a handheld barcode scanner associated with the ticket holder and dispenser 300 to scan instant lottery ticket information from the ticket(s) and/or pack(s). In various embodiments, the ticket holder and dispenser 300 employs a barcode scanner and scans the instant lottery ticket information.

After the instant lottery tickets have been loaded into the ticket holder and dispenser 300, the ticket holder and dispenser 300 sends the dispenser ticket supply data to the lottery central system 200, as indicated at block 2004.

In various embodiments, the dispenser ticket supply data: (1) enables the central lottery system 200 and/or the electronic ticket purchasing system 100 to provide an accurate listing of instant lottery tickets that are currently available for purchase to the purchaser (e.g., not out of stock); (2) enables inventory control for the instant lottery tickets (e.g., timely ordering and shipping of additional instant lottery tickets for loading into the ticket holder and dispenser 300); (3) tracking a location of instant lottery tickets for improved ticket security (e.g., to prevent tickets being unloaded and re-loaded by a nefarious actor); and/or (4) tracking of ticket purchase data for the scratch-off instant lottery ticket auto-reveal system 10.

In various embodiments, the lottery central system 200 activates the instant lottery tickets to enable redemption of those activated instant lottery tickets and prevent redemption of inactivated instant lottery tickets. In some scenarios, activation of the instant lottery tickets enables the scratch-off instant lottery ticket auto-reveal system 10 to reduce a likelihood of a nefarious actor stealing or misappropriating instant lottery tickets, for example, during shipment to the ticket holder and dispenser 300, when those tickets have not yet been activated and cannot be redeemed.

In various embodiments, the lottery central system 200 does not activate the instant lottery tickets when they are loaded into the ticket holder and dispenser 300. By delaying activation until a later time (e.g., at the time of purchase), the lottery central system 200 enables improved security for instant lottery tickets by: (1) reducing or eliminating a duration of time in which an instant lottery ticket is susceptible to theft or fraud (i.e., after the instant lottery ticket has been activated and is redeemable but before the instant lottery ticket has been paid for); (2) enabling incorrectly dispensed tickets that do not match a purchased instant lottery ticket to be discarded without risk of a nefarious actor attempting to redeem the discarded ticket.

For the purchase of an instant lottery ticket, the electronic ticket purchasing system 100 employs user inputs from a purchaser to cause a purchased instant lottery ticket to be dispensed, as indicated at block 2006.

In various embodiments, the electronic ticket purchasing system 100 displays indications of a plurality of different instant lottery tickets available for purchase. In various embodiments, the electronic ticket purchasing system 100 receives available ticket data from the lottery central system 200 and displays the indications based on the available ticket data. In various embodiments, the electronic ticket purchasing system 100 does not display indications for instant lottery tickets that are out of stock at the ticket holder and dispenser 300, not permitted for sale to that purchaser (e.g., due to jurisdictional constraints), and/or have been previously filtered by the purchaser (e.g., by selecting purchase price limit(s), preferred game type(s)).

In various embodiments, the electronic ticket purchasing system 100 receives user inputs (e.g., from a touch-screen display, buttons, or other suitable user input device) that indicate a game type of a purchased instant lottery ticket. Based on the indicated game type, the electronic ticket purchasing system 100 generates an order for the purchased instant lottery ticket and sends the order to the lottery central system 200. In various embodiments, the order includes the purchased instant lottery ticket data 110 described above. In various embodiments, the order includes an order identifier, a game identifier, and a purchaser digital signature.

The lottery central system 200 processes the order to identify a lottery ticket holder and dispenser 300 and routes the order to the selected lottery ticket holder and dispenser 300, as indicated at block 2008.

In various embodiments, the lottery central system 200 employs the dispenser ticket supply data to identify an appropriate lottery ticket holder and dispenser 300 from which the purchased instant lottery ticket can be dispensed. In various embodiments, the lottery central system 200 identifies a particular lottery ticket holder and dispenser 300 that has a sufficient inventory of instant lottery tickets to dispense the purchased instant lottery ticket.

The identified lottery ticket holder and dispenser 300 receives the order and dispenses the purchased instant lottery ticket, as indicated at block 2010. In various embodiments, the order includes the game ID for the purchased instant lottery ticket. The lottery ticket holder and dispenser 300 identifies a ticket drawer holding tickets with that game ID and causes the ticket drawer and an associated movable ticket burster to dispense the purchased instant lottery ticket.

The lottery ticket holder and dispenser 300 provides the dispensed ticket to the ticket activator 400. In various embodiments, the lottery ticket holder and dispenser 300 dispenses the purchased instant lottery ticket directly into the ticket activator 400 (e.g., via the ticket inlet of the ticket activator 400).

To enable activation of the dispensed ticket, the ticket activator 400 receives the dispensed ticket and provides a ticket identifier associated with the dispensed ticket to the lottery central system 200, as indicated at block 2012.

In various embodiments, the ticket activator 400 employs the barcode scanner to obtain the ticket identifier from the instant lottery ticket information on the dispensed ticket. The ticket activator 400 sends the ticket identifier to the lottery central system 200 via the data communication interface.

In various embodiments, the ticket activator 400 verifies a game ID for the dispensed ticket before providing the ticket identifier to the lottery central system 200. The ticket activator 400 employs the barcode scanner to obtain a game ID from the dispensed ticket. The ticket activator 400 receives a game ID from the lottery central system 200 (e.g., from the purchased instant lottery ticket data 110). The ticket activator 400 compares the game ID received from the lottery central system 200 with the game ID from the dispensed ticket. When the ticket activator 400 determines that the game IDs match, the ticket activator 400 provides the ticket identifier to the lottery central system 200. When the ticket activator 400 determines that the game IDs do not match, the ticket activator 400 causes an alternate ticket handling process, such as providing an error message to the lottery central system 200, disposing of the dispensed ticket, and/or causing the lottery ticket holder and dispenser 300 to dispense another instant lottery ticket.

After providing the ticket identifier to the lottery central system 200, the ticket activator 400 provides the dispensed ticket to the first ticket image provider 500. In various embodiments, the ticket outlet of the ticket activator 400 is aligned with and provides the dispensed ticket to the ticket inlet of the first ticket image provider 500.

The lottery central system 200 employs the ticket identifier to activate and assign the dispensed ticket, as indicated at block 2014.

In various embodiments, the lottery central system 200 delays activation of an instant lottery ticket until that instant lottery ticket has been purchased to enable improved ticket security, as described above.

In various embodiments, the lottery central system 200 verifies a game ID for the dispensed ticket before activating the dispensed ticket. The lottery central system 200 compares a game ID associated with the dispensed ticket with the game ID from the purchased instant lottery ticket data 110. When the lottery central system 200 determines that the game IDs match, the lottery central system 200 activates the dispensed ticket. When the lottery central system 200 determines that the game IDs do not match, the lottery central system 200 causes an alternate ticket handling process, such as providing an error message (e.g., to the electronic ticket purchasing system 100 or ticket activator 400), causing the ticket activator 400 to discard the dispensed ticket, and/or causing the lottery ticket holder and dispenser 300 to dispense another instant lottery ticket. In various embodiments, the lottery central system 200 enables discarded but inactivated tickets to be sold (e.g., reloaded into the lottery ticket holder and dispenser 300).

In various embodiments, the lottery central system 200 verifies a pack status for the pack of instant lottery tickets associated with the dispensed ticket. For example, the lottery central system 200 verifies that the pack has been properly loaded into a ticket holder and dispenser 300 and not lost or stolen.

Once the dispensed ticket is activated, the lottery central system 200 assigns the dispensed ticket to the purchaser. For example, the lottery central system 200 updates the ticket assignment data for the dispensed ticket to include the player ID associated with the purchaser of that dispensed ticket. By updating the ticket assignment data, the lottery central system 200 enables improved ticket security. In various embodiments, the lottery central system 200 restricts redemption of a dispensed ticket to an entity associated with the player ID assigned to that dispensed ticket.

After activation and assignment, the first ticket image provider 500 provides first image data for the dispensed ticket with the SOC in-tact to the lottery central system 200, as indicated at block 2016.

In various embodiments, the first ticket image provider 500 receives the dispensed ticket from the ticket activator 400 and captures image data for the dispensed ticket.

In this example embodiment, the first ticket image provider 500 employs the first image capture device to capture image data for the front surface of the dispensed ticket with the SOC in-tact. The first ticket image provider 500 employs the second image capture device to capture image data for the back surface of the dispensed ticket. The image data for the front surface and the back surface of the dispensed ticket (i.e., with the SOC in-tact) are collectively referred to herein as first image data.

The first ticket image provider 500 provides the first image data to the lottery central system 200. In various embodiments, the lottery central system 200 enables improved security of the dispensed ticket, for example, by enabling verification that the dispensed ticket has not been damaged and/or tampered with prior to being stored and/or provided to a purchaser. In the event of damage to the dispensed ticket (e.g., by the purchaser, by the ticket revealer 600, by another entity), the lottery central system 200 enables an estimate of when such damage occurred based on a visual evaluation of the first image data.

In various embodiments, the lottery central system 200 provides an image of the dispensed ticket with the SOC in-tact to the electronic ticket purchasing system 100 to enable the purchaser to view the dispensed ticket. In various embodiments, the lottery central system 200 sends the first image data to the electronic ticket purchasing system 100. In various embodiments, the lottery central system 200 sends image data of the instant lottery ticket that was previously stored (e.g., after manufacture of the instant lottery ticket and prior to loading of the instant lottery ticket into the ticket holder and dispenser 300).

After providing the first image data to the lottery central system 200, the first ticket image provider 500 provides the dispensed ticket to the ticket revealer 600. In various embodiments, the ticket outlet of the first ticket image provider 500 is aligned with and provides the dispensed ticket to the ticket inlet of the ticket revealer 600.

The ticket revealer 600 removes the SOC from the dispensed ticket, as indicated at block 2018.

In various embodiments, the ticket revealer 600 physically removes all or a portion of the SOC on the dispensed ticket. In various embodiments, the ticket revealer 600 removes all of the SOC from the predefined scratch-off area of the dispensed ticket. In various embodiments, the ticket revealer 600 removes only the SOC that covers the validation barcode printed on the predefined scratch-off area. In various embodiments, the ticket revealer 600 removes the SOC that covers the validation barcode and the variable lottery game symbols printed on the predefined scratch-off.

After removal of the SOC of the dispensed ticket, the dispensed ticket then becomes a revealed ticket as referred to herein. With the SOC removed, the ticket revealer 600 enables the features printed on the predefined scratch-off area of the revealed ticket to be viewed (e.g., by a clerk or purchaser), imaged (e.g., by an image capture device), and/or scanned (e.g., by a barcode scanner).

In various embodiments, the ticket revealer 600 activates the SOC fragment remover to remove residual fragments of the SOC, as described above.

After removing the SOC, the ticket revealer 600 provides the revealed ticket to the second ticket image provider 700. In various embodiments, the ticket outlet of the ticket revealer 600 is aligned with and provides the revealed ticket to the ticket inlet of the second ticket image provider 700.

The second ticket image provider 700 provides revealed ticket image data for the revealed ticket with the SOC removed to the lottery central system 200, as indicated at block 2020.

The second ticket image provider 700 receives the revealed ticket from the ticket revealer 600 and captures image data for the revealed ticket.

In various embodiments, the second ticket image provider 700 employs the first image capture device to capture image data for the front surface of the revealed ticket with the SOC removed. In various embodiments, the second ticket image provider 700 employs the second image capture device to capture image data for the back surface of the revealed ticket. The image data for the front surface and the back surface of the revealed ticket (i.e., with the SOC removed) are collectively referred to herein as second image data or revealed ticket image data.

The second ticket image provider 700 provides the revealed ticket image data to the lottery central system 200. In various embodiments, the lottery central system 200 enables improved security of the revealed ticket, for example, by enabling verification that the revealed ticket has not been damaged and/or tampered with prior to being stored and/or provided to a purchaser. In the event of damage to the revealed ticket (e.g., by the purchaser, by the ticket revealer 600, by another entity), the lottery central system 200 enables an estimate of when such damage occurred based on a visual evaluation of the revealed ticket image data. Specifically, revealed ticket image data can indicate that the revealed ticket was not damaged by the ticket revealer 600.

In various embodiments, the lottery central system 200 provides an image of the revealed ticket with the SOC removed to the electronic ticket purchasing system 100 to enable the purchaser to view the revealed ticket. For example, the lottery central system 200 sends the second image data to the electronic ticket purchasing system 100.

After providing the revealed ticket image data, the second ticket image provider 700 provides the revealed ticket to the ticket validator 800. In various embodiments, the ticket outlet of the second ticket image provider 700 is aligned with and provides the revealed ticket to the ticket inlet of the ticket validator 800.

The ticket validator 800 obtains the validation identifier for the revealed ticket, as indicated at block 2022.

In various embodiments, the ticket validator 800 employs the barcode scanner 830 to obtain the validation identifier, as described above.

The ticket validator 800 obtains an award tier identifier associated with the revealed ticket, as indicated at block 2024.

In various embodiments, the ticket validator 800 provides the validation identifier associated with the revealed ticket to the lottery central system 200. The lottery central system 200 employs the validation identifier to determine the award tier identifier associated with the revealed ticket. The award tier identifier identifies one of a plurality of award tiers associated with the revealed ticket, as described above. The lottery central system 200 sends the award tier identifier to the ticket validator 800.

In various embodiments, the lottery central system 200 provides an award notification to the purchaser based on the award tier identifier. In various embodiments, the award notification includes an amount won for the purchased instant lottery ticket. In various embodiments, the award notification includes image data for the revealed ticket (e.g., with the SOC removed). In various embodiments, the lottery central system 200 sends the award notification to the electronic ticket purchasing system 100. In various embodiments, the lottery central system 200 employs the lottery API gateway 210 to send the award notification to the electronic ticket purchasing system 100. In various embodiments, the lottery central system 200 employs the ticket identifier for the revealed ticket to obtain an order identifier for the order associated with the revealed ticket. In these embodiments, the lottery central system 200 employs the order identifier to obtain the player identifier and subsequently contact the player.

The ticket validator 800 imprints ticket ownership information onto the revealed ticket, as indicated at block 2026.

In various embodiments, the ticket ownership information includes the player ID of the purchaser of the revealed ticket. In various embodiments, the ticket validator 800 receives the ticket ownership information from the lottery central system 200. In various embodiments, the ticket validator 800 receives the ticket ownership information after providing the validation identifier to the lottery central system 200.

The ticket validator 800 employs the ticket ownership labeling device to imprint the player ID onto the revealed ticket. In various embodiments, the ticket ownership labeling device imprints the player ID onto the back surface of the revealed ticket, onto the front surface of the revealed ticket, or onto both the back and front surfaces.

The ticket validator 800 assigns a secure storage bin identifier to the revealed ticket based on the award tier identifier received from the lottery central system 200, as indicated at block 2028.

The secure storage bin identifier indicates one of the plurality of secure storage bins of the revealed ticket storer 900 into which the revealed ticket should be stored. In various embodiments, the award tier identifier is the same as the secure storage bin identifier. In various embodiments, the ticket validator 800 assigns a secure storage bin identifier that is different from the award tier identifier.

In this example embodiment, ticket validator 800 provides the award tier identifier as the secure storage bin identifier.

The ticket validator 800 provides the secure storage bin identifier and the revealed ticket to the revealed ticket storer 900. In various embodiments, the ticket outlet of the ticket validator 800 is aligned with and provides the revealed ticket to the ticket inlet of the revealed ticket storer 900.

The revealed ticket storer 900 stores the revealed ticket in the secure storage bin associated with the secure storage bin identifier, as indicated at block 2030.

The ticket routing device employs the secure storage bin identifier to identify the secure storage bin into which the revealed ticket should be stored. The ticket routing device activates the ticket engagers to route the revealed ticket to the identified secure storage bin.

In various embodiments, the revealed tickets are transferred to a claim location to be retrieved by the purchaser. In various embodiments, the purchaser provides the order ID for the order associated with the revealed ticket, the ticket identifier of the revealed ticket, and/or the player identifier associated with the purchaser to confirm ownership of the revealed ticket. In various embodiments, the purchaser provides purchaser identifying information to re-generate the purchaser digital signature and verify ownership of the revealed ticket.

Various changes and modifications to the present embodiments described herein will be apparent to those skilled in the art. Such changes and modifications can be made without departing from the spirit and scope of the present subject matter and without diminishing its intended technical scope. It is therefore intended that such changes and modifications be covered by the appended claims.

The claims are as follows:

1. A scratch-off instant lottery ticket auto-reveal system comprising:
a lottery ticket holder and dispenser that comprises:
a housing,
a plurality of ticket drawers in the housing, each of the plurality of ticket drawers configured to hold a pack of instant lottery tickets, each of the instant lottery tickets comprising:
a ticket barcode associated with a ticket identifier that uniquely identifies that instant lottery ticket,
a validation barcode associated with a validation identifier for that instant lottery ticket, and
a scratch-off coating (“SOC”) covering the validation barcode,
one or more ticket bursters in the housing, each ticket burster operable to receive a purchased instant lottery ticket from one of the plurality of ticket drawers and dispense that purchased instant lottery ticket,
wherein the lottery ticket holder and dispenser is operable to:
track dispenser ticket supply data for instant lottery tickets loaded into the plurality of ticket drawers based on the ticket identifiers for the loaded instant lottery tickets, and
provide the dispenser ticket supply data to a lottery central system;
a barcode scanner operable to scan the ticket barcode printed on the purchased instant lottery ticket to obtain the ticket identifier for the purchased instant lottery ticket;
a ticket activator operable to provide the ticket identifier of the purchased instant lottery ticket to the lottery central system to enable activation of the purchased instant lottery ticket by the lottery central system;
a ticket revealer comprising an SOC remover operable to remove the SOC covering the validation barcode of the purchased instant lottery ticket to obtain a revealed instant lottery ticket;
a ticket imager provider operable to capture image data for the revealed instant lottery ticket with the SOC removed from the validation barcode, the ticket image provider operable to provide the image data to the lottery central system; and
a ticket validator operable to provide the validation identifier of the revealed instant lottery ticket to the lottery central system.

2. The scratch-off instant lottery ticket auto-reveal system of claim 1, wherein the image data comprises still image data.

3. The scratch-off instant lottery ticket auto-reveal system of claim 1, wherein the ticket image provider comprises a still image capture device configured to capture still image data.

4. The scratch-off instant lottery ticket auto-reveal system of claim 1, wherein:
the image data for the revealed instant lottery ticket with the SOC removed from the validation barcode comprises second image data,
the ticket image provider is operable to capture first image data for the purchased instant lottery ticket with the SOC covering the validation barcode, and
the ticket image provider is operable to provide the first image data to the lottery central system.

5. The scratch-off instant lottery ticket auto-reveal system of claim 4, wherein the first image data comprises still image data.

6. The scratch-off instant lottery ticket auto-reveal system of claim 4, wherein:
the ticket revealer comprises a ticket movement path and a plurality of ticket engagers; and
the plurality of ticket engagers are positioned to:
move the purchased instant lottery ticket forward through the ticket movement path to the ticket image provider to enable the capture of the first image data for the purchased instant lottery ticket with the SOC covering the validation barcode,
move the purchased instant lottery ticket backward through the ticket movement path to the SOC remover to enable the removal of the SOC covering, and
move the revealed instant lottery ticket forward through the ticket movement path to the ticket image provider to enable the capture of the second image data for the revealed instant lottery ticket with the SOC removed from the validation barcode.

7. The scratch-off instant lottery ticket auto-reveal system of claim 1, the barcode scanner is operable to scan the ticket barcodes of the loaded instant lottery tickets to obtain the ticket identifiers for the loaded instant lottery tickets.

8. The scratch-off instant lottery ticket auto-reveal system of claim 1, wherein the barcode scanner is operable to scan the validation barcode printed on the revealed instant lottery ticket to obtain the validation identifier of the revealed instant lottery ticket.

9. The scratch-off instant lottery ticket auto-reveal system of claim 1, wherein the ticket activator comprises the barcode scanner.

10. The scratch-off instant lottery ticket auto-reveal system of claim 9, wherein the ticket activator is operable to:
receive a game identifier associated with an order for the purchased instant lottery ticket;
employ the barcode scanner to obtain scanned ticket data for the purchased instant lottery ticket, the scanned ticket data comprising a scanned game identifier;
compare the received game identifier with the scanned game identifier; and
cause the purchased instant lottery ticket to be discarded without activation of the purchased instant lottery ticket if the received game identifier and the scanned game identifier do not match.

11. The scratch-off instant lottery ticket auto-reveal system of claim 9, wherein:
the barcode scanner comprises a first barcode scanner;
the lottery ticket holder and dispenser comprises a second barcode scanner; and
the second barcode scanner is operable to scan the ticket barcodes of the loaded instant lottery tickets to obtain the ticket identifiers for the loaded instant lottery tickets.

12. The scratch-off instant lottery ticket auto-reveal system of claim 9, wherein:
the barcode scanner comprises a first barcode scanner;
the ticket validator comprises a second barcode scanner; and
the second barcode scanner is operable to scan the validation barcode printed on the revealed instant lottery ticket to obtain the validation identifier of the revealed instant lottery ticket.

13. The scratch-off instant lottery ticket auto-reveal system of claim 12, wherein:
the lottery ticket holder and dispenser comprises a third barcode scanner; and
the third barcode scanner is operable to scan the ticket barcodes of the loaded instant lottery tickets to obtain the ticket identifiers for the loaded instant lottery tickets.

14. The scratch-off instant lottery ticket auto-reveal system of claim 1, wherein each ticket burster:
defines a ticket inlet and a ticket outlet,
is movable to a plurality of different ticket receipt positions, each different ticket receipt position associated with and in alignment with a different one of the plurality of ticket drawers, and
is movable to a ticket dispense position of the lottery ticket holder and dispenser,
wherein each ticket burster is operable to separate the purchased instant lottery ticket from the pack of instant lottery tickets and provide the purchased instant lottery ticket to the ticket activator to enable the activation of the purchased instant lottery ticket.

15. The scratch-off instant lottery ticket auto-reveal system of claim 1, wherein the ticket validator comprises a ticket ownership labeling device operable to imprint ticket ownership information onto the revealed ticket, wherein the ticket ownership information comprises a player identifier that identifies a purchaser account associated with the revealed instant lottery ticket.

16. The scratch-off instant lottery ticket auto-reveal system of claim 1, wherein the ticket validator is operable to:
receive an award tier identifier associated with the revealed ticket from the lottery central system,
assign a secure storage bin identifier to the revealed ticket based on the award tier identifier, and
provide the secure storage bin identifier to a revealed ticket storer.

17. A scratch-off instant lottery ticket auto-reveal system comprising:
a lottery ticket holder and dispenser that comprises:
a first housing,
a plurality of ticket drawers in the housing, each of the plurality of ticket drawers configured to hold a pack of instant lottery tickets, each of the instant lottery tickets comprising:
a ticket barcode on a back surface of the instant lottery ticket, the ticket barcode associated with a ticket identifier that uniquely identifies that instant lottery ticket,
a validation barcode on a front surface of the instant lottery ticket, the validation barcode associated with a validation identifier for that instant lottery ticket, and
a scratch-off coating (“SOC”) covering the validation barcode,
one or more ticket bursters in the housing, each ticket burster operable to receive a purchased instant lottery ticket from one of the plurality of ticket drawers and dispense that purchased instant lottery ticket,
a barcode scanner operable to scan the ticket barcode printed on the back surface of the purchased instant lottery ticket to obtain the ticket identifier for the purchased instant lottery ticket;
a ticket activator operable to provide the ticket identifier of the purchased instant lottery ticket to a lottery central system to enable activation of the purchased instant lottery ticket by the lottery central system;
a ticket revealer comprising an SOC remover operable to remove the SOC covering the validation barcode of the purchased instant lottery ticket to obtain a revealed instant lottery ticket;
a ticket imager provider operable to capture image data for the revealed instant lottery ticket with the SOC removed from the validation barcode, the ticket image provider operable to provide the image data to the lottery central system; and
a ticket validator operable to provide the validation identifier of the revealed instant lottery ticket to the lottery central system.

18. The scratch-off instant lottery ticket auto-reveal system of claim 17, wherein:
the image data for the revealed instant lottery ticket with the SOC removed from the validation barcode comprises second image data,
the ticket image provider is operable to capture first image data for the purchased instant lottery ticket with the SOC covering the validation barcode, and
the ticket image provider is operable to provide the first image data to the lottery central system.

19. A scratch-off instant lottery ticket auto-reveal system comprising:
a lottery ticket holder and dispenser that comprises:
a first housing,
a plurality of ticket drawers in the housing, each of the plurality of ticket drawers configured to hold a pack of instant lottery tickets, each of the instant lottery tickets comprising:
a ticket barcode on a back surface of the instant lottery ticket, the ticket barcode associated with a ticket identifier that uniquely identifies that instant lottery ticket,
a validation barcode on a front surface of the instant lottery ticket, the validation barcode associated with a validation identifier for that instant lottery ticket, and
a scratch-off coating (“SOC”) covering the validation barcode,
one or more ticket bursters in the housing, each ticket burster operable to receive a purchased instant lottery ticket from one of the plurality of ticket drawers and dispense that purchased instant lottery ticket,
a barcode scanner operable to scan the ticket barcode printed on the back surface of the purchased instant lottery ticket to obtain the ticket identifier for the purchased instant lottery ticket;
a ticket activator operable to provide the ticket identifier of the purchased instant lottery ticket to a lottery central system;
a ticket revealer comprising an SOC remover operable to remove the SOC covering the validation barcode of the purchased instant lottery ticket to obtain a revealed instant lottery ticket; and
a combined ticket imager provider and ticket validator operable to capture image data for the revealed instant lottery ticket with the SOC removed from the validation barcode, and to provide the image data to the lottery central system that comprises the validation identifier of the revealed instant lottery ticket.

20. The scratch-off instant lottery ticket auto-reveal system of claim 19, wherein the image data for the revealed instant lottery ticket with the SOC removed comprises variable symbols on the substrate.
